(19) United States
(12) Patent Application Publication
(10) Pub. No.: US 2012/0045989 A1
(43) Pub. Date: Feb. 23, 2012

(54) DEVICE DISCOVERY IN NEAR-FIELD COMMUNICATION

(75) Inventors: Jan SUUMÄKI, Lempaala (FI); Mikko SAARISALO, Kantvik (FI)

(73) Assignee: Nokia Corporation, Espoo (FI)

(21) Appl. No.: 12/858,545

(22) Filed: Aug. 18, 2010

(51) Int. Cl. H04B 5/00

(52) U.S. Cl. 455/41.1

(57) ABSTRACT

Example method, apparatus, and computer program product embodiments are disclosed to improve device discovery in near-field communication. Example embodiments of the invention include a wireless host device coupled to a near-field communication (NFC) controller via an NFC controller interface (NCI), the NFC controller capable of exchanging NFC radio frequency (RF) signals with other NFC controllers or with NFC tags, according to an embodiment of the present invention. In example embodiments of an NFC discovery RF signal sequence may be exchanged between two NFC controllers, each sequence of RF signals comprising a plurality of discovery periods including a poll interval, a listen interval, and an idle interval. Several methods are disclosed to improve the probability of detection of another NFC device by modifying the format of the discovery period.

### FIELD

The field of the invention relates to near-field communication, and more particularly to improvements to device discovery in near-field communication.

### BACKGROUND

Modern society has adopted, and is becoming reliant upon, wireless communication devices for various purposes, such as connecting users of the wireless communication devices with other users. Wireless communication devices can vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2β digital cellular network communicating in the 900 MHZ/1.8 GHZ bands in Europe and at 850 MHz and 1.9 GHZ in the United States. While long-range communication networks, like GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth™ is an example of a short-range wireless technology quickly gaining acceptance in the marketplace. In addition to Bluetooth™ other popular short-range communication technologies include Bluetooth™ Low Energy, IEEE 802.11 wireless local area network (WLAN), Wireless USB (WUSB), Ultra Wide-band (UWB), ZigBee (IEEE 802.15.4, IEEE 802.15.4a), and radio frequency identification (RFID) technologies. All of these wireless communication technologies have features and advantages that make them appropriate for various applications.

Near-field communication technologies, such s radio frequency identification (RFID) technologies, comprise a range of RF transmission systems, for example standardized and proprietary systems for a large number of different purposes, such as product tagging for inventory handling and logistics, theft prevention purposes at the point of sale, and product recycling at the end of the life-cycle of the tagged product. In addition to RFID technologies, Near-Field Communication (NFC) technology has recently evolved from a combination of existing contactless identification and interconnection technologies. NFC is both a “read” and “write” technology. Communication between two NFC-compatible devices occurs when they are brought within close proximity of each other: A simple wave or touch can initiate establishment of an NFC connection.

### SUMMARY

Example method, apparatus, and computer program product embodiments are disclosed to improve device discovery in near-field communication. Several methods are disclosed to improve the probability of detection of another NFC device by modifying the format of the discovery period. An example format of the NFC discovery period may include specifying the duration of the discovery period, the duration of the poll interval, the duration of the listen interval, and/or the duration of the idle interval. The format of the NFC discovery period may also include specifying a periodic skipping of polling for certain NFC technologies.

In an example embodiment, a sequence of method steps is carried out by generating a sequence of NFC discovery periods, each discovery period having a format based on parameters for formatting to increase a probability of discovering another NFC device, according to an embodiment of the present invention. The example steps comprise:

receiving parameters for formatting a near-field communication discovery period;

generating a sequence of near-field communication discovery periods, each discovery period having a format based on the received parameters for formatting; and

initiating transmission of a near-field communication discovery RF signal according to the generated sequence of near-field communication discovery periods.

In an example embodiment, a computer readable medium storing program instructions, which when executed by a computer processor, performs the immediately preceding method steps.

In an example embodiment, an apparatus comprises:

at least one processor;

at least one memory including computer program code;

the at least one memory and the computer program code configured to, with the at least one processor, cause the apparatus at least to:
receive parameters for formatting an near-field communication discovery period;
generate a sequence of near-field communication discovery periods, each discovery period having a format based on the received parameters for formatting; and
initiate transmission of an near-field communication discovery RF signal according to the generated sequence of near-field communication discovery periods.

In an example embodiment, a sequence of method steps is carried out to reduce unnecessary polling and enable longer listening intervals in NFC discovery, according to an embodiment of the present invention. The example steps comprise:

accessing a regional database to determine if there are certain near-field communication technologies that are not in use locally; and

providing to an near-field communication controller discovery parameters for those near-field communication technologies being used in the local region, to reduce unnecessary polling and enable longer listening intervals in near-field communication discovery.

In an example embodiment, a computer readable medium storing program instructions, which when executed by a computer processor, may perform the immediately preceding method steps.

In an example embodiment, an apparatus comprises:

at least one processor;

at least one memory including computer program code;

the at least one memory and the computer program code configured to, with the at least one processor, cause the apparatus at least to:

access a regional database to determine if there are certain near-field communication technologies that are not in use locally; and

provide to a near-field communication controller, discovery parameters for those near-field communication technologies being used in the local region, to reduce unnecessary polling and enable longer listening intervals in near-field communication discovery.

The resulting embodiments improve at least device discovery in near-field communication.

### DESCRIPTION OF THE FIGURES

FIG. 1A is an example embodiment of a wireless network diagram of two wireless devices, each comprising a host device coupled to an NFC controller via an NFC controller interface (NCI), the NFC controllers capable of exchanging near-field communication (NFC) RF signals, according to an embodiment of the present invention.

FIG. 1B is an example embodiment of the wireless host device coupled to the NFC controller via the NFC controller interface (NCI), showing a more detailed view of the NCI firmware in the NFC controller, according to an embodiment of the present invention.

FIG. 1C is an example embodiment of an NFC discovery RF signal sequence exchanged between the two NFC controllers of FIG. 1A, each sequence of RF signals comprising a poll interval, a listen interval, and an idle interval, FIG. 1C illustrating a relatively short period during which the listen interval of one device will overlap the poll interval of the other device, illustrating a relatively low probability that the devices may rapidly detect one another.

FIG. 1D is an example embodiment of an NFC discovery RF signal sequence exchanged between the two NFC controllers of FIG. 1A, each sequence of RF signals comprising a poll interval, a listen interval, and an idle interval, with the poll interval including three consecutive poll periods for an NFC-A poll, an NFC-B poll, and an NFC-F poll, respectively, according to an embodiment of the present invention.

FIG. 2A is an example embodiment of the NFC controller interface (NCI) between an NCI driver in the host device and an NCI firmware in the NFC controller coupled to the host device of FIG. 1A or 1B, wherein the NFC controller interface (NCI) receives from the host a Set command to configure several discovery related parameters, including a maximum value and a minimum value for the total duration of the discovery period. The NFC controller then starts discovery and generates an NFC discovery RF signal sequence of random total durations of the discovery period, to increase the probability that the listen interval of one device will overlap the poll interval of the other device, according to an embodiment of the present invention.

FIG. 2B is an example embodiment of the format of a first discovery period in the NFC discovery RF signal sequence, having a random total duration generated by the NFC controller of FIG. 2A, according to an embodiment of the present invention.

FIG. 2C is an example embodiment of the format of a second discovery period in the NFC discovery RF signal sequence, having a random total duration generated by the NFC controller of FIG. 2A, which is shorter than that shown in FIG. 2B, according to an embodiment of the present invention.

FIG. 2D is an example embodiment of the format of a third discovery period in the NFC discovery RF signal sequence, having a random total duration generated by the NFC controller of FIG. 2A, which is between those shown in FIGS. 2B and 2C, according to an embodiment of the present invention.

FIG. 2E is an example embodiment of the format of a first discovery period in the NFC discovery RF signal sequence, having a random total duration generated by the NFC controller of FIG. 2A, including polling for the different technologies NFC-A, NFC-B and NFC-F, according to an embodiment of the present invention.

FIG. 2F is an example embodiment of the format of a second discovery period in the NFC discovery RF signal sequence, having a random total duration generated by the NFC controller of FIG. 2A, including polling for the different technologies NFC-A, NFC-B and NFC-F, which is shorter than that shown in FIG. 2B, according to an embodiment of the present invention.

FIG. 2G is an example embodiment of the format of a third discovery period in the NFC discovery RF signal sequence, having a random total duration generated by the NFC controller of FIG. 2A, including polling for the different technologies NFC-A, NFC-B and NFC-F, which is between those shown in FIGS. 2B and 2C, according to an embodiment of the present invention.

FIG. 2H is an example embodiment of the NFC controller interface (NCI) between an NCI driver in the host device and an NCI firmware in the NFC controller coupled to the host device of FIG. 1A or 1B, wherein the NFC controller interface (NCI) receives from the host a Set command to configure several discovery related parameters, including a maximum value and a minimum value for the idle interval of the discovery period. The NFC controller then starts discovery and generates a NFC discovery RF signal sequence of random values for the idle interval of the discovery period, to increase the probability that the listen interval of one device will overlap the poll interval of the other device, enabling the two devices to more rapidly detect one another, according to an embodiment of the present invention. The NFC controller of FIG. 2H generates the example embodiments of the format of the discovery period shown in FIGS. 2B to 2G.

FIG. 3A is an example embodiment of the NFC controller interface (NCI) between an NCI driver in the host device and an NCI firmware in the NFC controller coupled to the host device of FIG. 1A or 1B, wherein the NFC controller interface (NCI) receives from the host a Set command to configure several discovery related parameters, including a maximum value and a minimum value for the listen interval of the discovery period. The NFC controller then starts discovery and generates a NFC discovery RF signal sequence of random values for the listen interval of the discovery period, to increase the probability that the listen interval of one device will overlap the poll interval of the other device, enabling the two devices to more rapidly detect one another, according to an embodiment of the present invention.

FIG. 3B is an example embodiment of the format of a first discovery period in the NFC discovery RF signal sequence, having a random listen interval generated by the NFC controller of FIG. 3A, according to an embodiment of the present invention.

FIG. 3C is an example embodiment of the format of a second discovery period in the NFC discovery RF signal sequence, having a random listen interval generated by the NFC controller of FIG. 3A, wherein the listen interval is longer than that shown in FIG. 3B, according to an embodiment of the present invention.

FIG. 3D is an example embodiment of the format of a third discovery period in the NFC discovery RF signal sequence, having a random listen interval generated by the NFC controller of FIG. 3A, which is between those shown in FIGS. 3B and 3C, according to an embodiment of the present invention.

FIG. 3E is an example embodiment of the format of a first discovery period in the NFC discovery RF signal sequence, having a random listen interval generated by the NFC controller of FIG. 3A, including polling for the different technologies NFC-A, NFC-B and NFC-F, according to an embodiment of the present invention.

FIG. 3F is an example embodiment of the format of a second discovery period in the NFC discovery RF signal sequence, having a random listen interval generated by the NFC controller of FIG. 3A, including polling for the different technologies NFC-A, NFC-B and NFC-F, wherein the listen interval is longer than that shown in FIG. 3B, according to an embodiment of the present invention.

FIG. 3G is an example embodiment of the format of a third discovery period in the NFC discovery RF signal sequence, having a random listen interval generated by the NFC controller of FIG. 3A, which is between those shown in FIGS. 3B and 3C, including polling for the different technologies NFC-A, NFC-B and NFC-F, according to an embodiment of the present invention.

FIG. 4A is an example embodiment of the NFC controller interface (NCI) between an NCI driver in the host device and an NCI firmware in the NFC controller coupled to the host device of FIG. 1A or 1B, wherein the NFC controller interface (NCI) receives from the host a Set command to configure several discovery related parameters, including a value for the total duration of the discovery period and a rate at which the listen interval may be periodically expanded to include the idle interval for the total duration of one discovery period in a repeated sequence of discovery periods. The NFC controller then starts discovery and generates a NFC discovery RF signal sequence in which the listen interval may be periodically expanded to include the idle interval for the total duration of one discovery period in a repeated sequence of discovery periods, to increase the probability that the listen interval of one device will overlap the poll interval of the other device, enabling the two devices to more rapidly detect one another, according to an embodiment of the present invention.

FIG. 4B is an example embodiment of the format of a first discovery period in the NFC discovery RF signal sequence, having a total duration with a normal listen interval and idle interval generated by the NFC controller of FIG. 4A, according to an embodiment of the present invention.

FIG. 4C is an example embodiment of the format of a second discovery period in the NFC discovery RF signal sequence, having a total duration with a normal listen interval and idle interval generated by the NFC controller of FIG. 4A, according to an embodiment of the present invention.

FIG. 4D is an example embodiment of the format of a third discovery period in the NFC discovery RF signal sequence, having a total duration in which the listen interval may be periodically expanded to include the idle interval for the total duration of one discovery period generated by the NFC controller of FIG. 4A, according to an embodiment of the present invention.

FIG. 4E is an example embodiment of the format of a first discovery period in the NFC discovery RF signal sequence, having a total duration with a normal listen interval and idle interval generated by the NFC controller of FIG. 4A, including polling for the different technologies NFC-A, NFC-B and NFC-F, according to an embodiment of the present invention.

FIG. 4F is an example embodiment of the format of a second discovery period in the NFC discovery RF signal sequence, having a total duration with a normal listen interval and idle interval generated by the NFC controller of FIG. 4A, including polling for the different technologies NFC-A, NFC-B and NFC-F, according to an embodiment of the present invention.

FIG. 4G is an example embodiment of the format of a third discovery period in the NFC discovery RF signal sequence, having a total duration in which the listen interval may be periodically expanded to include the idle interval for the total duration of one discovery period generated by the NFC controller of FIG. 4A, including polling for the different technologies NFC-A, NFC-B and NFC-F, according to an embodiment of the present invention.

FIG. 5A is an example embodiment of the NFC controller interface (NCI) between an NCI driver in the host device and an NCI firmware in the NFC controller coupled to the host device of FIG. 1A or 1B, wherein the host device accesses a regional database to determine if there are certain NFC technologies, for example, NFC-A, NFC-B, and/or NFC-F, that are not in use locally. The host device then sends to the NFC controller interface (NCI) a Set command to configure several discovery related parameters, but excluding discovery parameters for those NFC technologies that are not being used in the local region. The NFC controller then starts discovery and generates a NFC discovery RF signal sequence for only those NFC technologies that are being used in the local region, to reduce unnecessary polling and enable longer listening intervals with the same power consumption, to increase the probability that the listen interval of one device will overlap the poll interval of the other device, enabling the two devices to more rapidly detect one another, according to an embodiment of the present invention.

FIG. 5B is an example embodiment of the format of a discovery period in the NFC discovery RF signal sequence in a first region with NFC-A, NFC-B, and NFC-F, generated by the NFC controller of FIG. 5A, according to an embodiment of the present invention.

FIG. 5C is an example embodiment of the format of a second discovery period in the NFC discovery RF signal sequence in a second region with only NFC-A, generated by the NFC controller of FIG. 5A, according to an embodiment of the present invention.

FIG. 6 is an example embodiment of a flow diagram of operational steps of an example embodiment of the method carried out between the NCI driver in the host device and the NCI firmware in the NFC controller FIG. 2A, from the point of view of the NFC controller, for generating a sequence of random total durations of the NFC discovery period having values between the maximum value and the minimum value for the total duration of the NFC discovery period, according to an embodiment of the present invention.

FIG. 7 is an example embodiment of a flow diagram of operational steps of an example embodiment of the method carried out between the NCI driver in the host device and the NCI firmware in the NFC controller FIG. 3A, from the point of view of the NFC controller, for generating a sequence of random listen interval values between the maximum value and the minimum value for the listen interval of the NFC discovery period, according to an embodiment of the present invention.

FIG. 8 is an example embodiment of a flow diagram of operational steps of an example embodiment of the method carried out between the NCI driver in the host device and the NCI firmware in the NFC controller FIG. 4A, from the point of view of the NFC controller, for periodically replacing the idle interval with the listen interval of the NFC discovery period, the replacing being at a rate corresponding to the replacement value, according to an embodiment of the present invention.

FIG. 9 is an example embodiment of a flow diagram of operational steps of an example embodiment of the method carried out between the NCI driver in the host device and the NCI firmware in the NFC controller of FIG. 2A, 3A, or 4A, from the point of view of the NFC controller, for generating a sequence of NFC discovery periods, each discovery period having a format based on parameters for formatting to increase a probability of discovering another NFC device, according to an embodiment of the present invention.

FIG. 10 is an example embodiment of a flow diagram of operational steps of an example embodiment of the method carried out between the NCI driver in the host device and the NCI firmware in the NFC controller FIG. 2H, from the point of view of the NFC controller, for generating a sequence of random idle interval values between the maximum value and the minimum value for the idle interval of the NFC discovery period, according to an embodiment of the present invention.

FIG. 11 is an example embodiment of a flow diagram of operational steps of an example embodiment of the method carried out between the NCI driver in the host device and the NCI firmware in the NFC controller FIG. 5A, from the point of view of the host device, for providing to an NFC controller discovery parameters for those NFC technologies being used in the local region, to reduce unnecessary polling and enable longer listening intervals in NFC discovery, according to an embodiment of the present invention.

FIG. 12A is an example embodiment of the wireless host device coupled to the NFC controller via the NFC controller interface (NCI), similar to that shown in FIG. 1B, wherein the host device is shown performing an example initialization by sending to the NFC controller a Set command with discovery parameters for formatting an NFC discovery period to increase a probability of discovering another NFC device, FIG. 12A further showing an ambient light detection subsystem that may be used to trigger the host device to send a start discovery command to the NFC controller when the ambient light level is determined to be greater than a predetermined threshold, according to an embodiment of the present invention.

FIG. 12B is an example embodiment of the wireless host device coupled to the NFC controller via the NFC controller interface (NCI) of FIG. 12A, wherein the host device and the NFC controller are enclosed in a pocket or purse where there is a low light level causing the ambient light detection subsystem and host device determine that the ambient light level is less than the predetermined threshold, resulting in the host device withholding sending a start discovery command to the NFC controller, according to an embodiment of the present invention.

FIG. 12C is an example embodiment of the wireless host device coupled to the NFC controller via the NFC controller interface (NCI) of FIGS. 12A and 12B, wherein the host device and the NFC controller are withdrawn from the pocket or purse and into a higher light level causing the ambient light detection subsystem and host device determine that the ambient light level is greater than the predetermined threshold, resulting in the host device sending a start discovery command to the NFC controller to activate NFC polling based on the discovery parameters, according to an embodiment of the present invention.

FIG. 12D is an example embodiment of a flow diagram of operational steps of an example embodiment of the method carried out between the host device and the NFC controller of FIGS. 12A-12C, from the point of view of the host device, for initializing the NFC controller by sending a Set command with discovery parameters for formatting an NFC discovery period to increase a probability of discovering another NFC device, detecting an ambient light level, and sending a command to the NFC controller to start NFC discovery based on the discovery parameters, if the detected light level is greater than a predetermined threshold, according to an embodiment of the present invention.

FIG. 12E is an example embodiment of the wireless host device coupled to the NFC controller via the NFC controller interface (NCI) of FIGS. 12A and 12B, wherein the host device and the NFC controller are withdrawn from the pocket or purse by an accelerated motion shown by the acceleration vector, causing the acceleration detector, A/D converter, and acceleration threshold logic and the processor in the host device to determine that the acceleration level is greater than a predetermined threshold, resulting in the host device sending a command to the NFC controller to activate NFC polling based on the discovery parameters, according to an embodiment of the present invention.

FIG. 12F is an example embodiment of a flow diagram of operational steps of an example embodiment of the method carried out between the host device and the NFC controller of FIG. 12E, from the point of view of the host device, for initializing the NFC controller by sending a Set command with discovery parameters for formatting an NFC discovery period to increase a probability of discovering another NFC device, detecting an acceleration level, and sending a command to the NFC controller to start NFC discovery based on the discovery parameters, if the detected acceleration level is greater than a predetermined threshold, according to an embodiment of the present invention.

FIG. 12G is an example embodiment of a flow diagram of operational steps of an example embodiment of the method carried out between the host device and the NFC controller of FIGS. 12A, 12B, 12C, and 12E, from the point of view of the NFC controller, for generation of a sequence of NFC discovery periods having a format based on received parameters, in response to detecting a change in an ambient condition.

### DISCUSSION OF EXAMPLE EMBODIMENTS OF THE INVENTION

Near-field communication (NFC) technology communicates between two NFC Devices or between an NFC Device and an NFC Tag via magnetic field induction, where two loop antennas are located within each other's near-field, effectively energizing a wireless contact by forming an air-core transformer. An example NFC radio operates within the unlicensed radio frequency ISM band of 13.56 MHz, with a bandwidth of approximately 2 MHz over a typical distance of a few centimeters. NFC technology is an extension of the ISO/IEC 14443 proximity-card standard (incorporated herein by reference) for contactless smartcards and radio frequency ID (RFID) devices, which combines the interface of a contactless smartcard and a reader into a single device, and uses the ISO/IEC 18092 NFC communication standard (incorporated herein by reference) to enable two-way communication. An NFC radio may communicate with both existing ISO/IEC 14443 contactless smartcards and readers, as well as with other NFC devices by using ISO/IEC 18092.

An NFC device may operate in two different modes: active and passive. An active device generates its own radio frequency (RF) field, whereas a device in passive mode has to use inductive coupling to transmit data. In contrast to the active mode, no internal power source is required in the passive mode, since a device may be powered by the RF field of an active NFC device and transfer data using load modulation.

The NFC Forum™, a non-profit industry association, has released specifications that enable different operation modes called: tag emulation, read/write mode, and peer to peer communication. Furthermore, NFC Forum has defined specifications for NFC Data Exchange Format (NDEF), NFC Tag Types, NFC Record Type Definition, Logical Link Control Protocol, and Connection Handover Specifications. The ISO/IEC 18092 standard defines communication modes for Near-Field Communication Interface and Protocol (NFCIP-1) using inductively coupled devices operating at the center frequency of 13.56 MHz for interconnection of computer peripherals. The ISO/IEC 18092 standard specifies modulation schemes, codings, transfer speeds and frame format of the RF interface, initialization schemes, conditions required for data collision control during initialization, and a transport protocol including protocol activation and data exchange methods.

The NFC Data Exchange Format (NDEF) specification, NFC Forum Data Exchange Format (NDEF) Specification, NFC Forum™, 2006 (incorporated herein by reference), defines a common data format for NFC devices to exchange application or service specific data. An NDEF message is constructed of a number of NDEF records, with the first and the last record providing message begin and end markers. Between two NFC Devices, NDEF messages may be exchanged over the NFC Logical Link Control Protocol (LLCP) protocol, specified in NFC Forum Logical Link Control Protocol Specification, NFC Forum™, 2009 (incorporated herein by reference). The NFC Connection Handover specification, NFC Forum Connection Handover Specification, NFC Forum™, 2008 (incorporated herein by reference), defines the exchange of NDEF messages between two NFC Devices in a negotiated handover to discover and negotiate alternative wireless communication technologies.

The NFC Digital Protocol Candidate Technical Specification, NFC Digital Protocol Candidate Technical Specification, NFC Forum™, NFCForum-TS-Digital Protocol-2009-Apr.-3 (incorporated herein by reference), addresses the digital protocol for NFC-enabled device communication, providing an implementation specification on top of the ISO/IEC 18092 and ISO/IEC 14443 standards. It harmonizes the integrated technologies, specifies implementation options and limits the interpretation of the standards for using NFC, ISO/IEC 14443 and JIS X6319-4 standards. It ensures global interoperability between different NFC devices, and between NFC devices and existing contactless infrastructure. The specification defines the common feature set that can be used consistently and without further modification for major NFC applications in areas such as financial services and public transport. The specification covers the digital interface and the half-duplex transmission protocol of the NFC-enabled device in its four roles as Initiator, Target, Reader/Writer and Card Emulator. It includes bit level coding, bit rates, frame formats, protocols, and command sets, which are used by NFC-enabled devices to exchange data and bind to the LLCP protocol.

The NFC Digital Protocol Candidate Technical Specification describes the poll mode and listen mode for three principal NFC technologies, NFC-A (normal), NFC-B (banking/short range), and NFC-F, a contactless RFID smart card system, primarily used in electronic money cards in Japan. Each of the NFC technologies is defined by a group of parameters that make a complete communication protocol. The parameters include RF carrier, communication mode, bit rate, modulation scheme, bit level coding, frame format, protocol, and command set. The three technologies use the same 13.56 MHz carrier. Each technology uses its own modulation scheme, bit level coding, and frame format, but may have the same protocol and command set.

The NFC Activity Candidate Technical Specification, NFC Activity Specification Candidate Technical Specification, NFC Forum™, NFCForum-TS-Activity-1.0_Candidate-1, 2010-03-12, (incorporated herein by reference), describes how the NFC Digital Protocol Specification can be used to set up the communication protocol with another NFC device or NFC Forum tag. It describes the building blocks, called Activities, for setting up the communication protocol. Activities are combined in Profiles that has specific Configuration Parameters and covers a particular use case. It defines Profiles for polling an NFC device and establishment of Peer to Peer communication, polling for and reading of NFC Data Exchange Format (NDEF) data from an NFC Forum tag, and polling for a NFC tag or NFC device in combination.

The NFC Forum™ is preparing an unpublished technical specification, NFC Controller Interface (NCI) Technical Specification, NCI [1.0 Draft 4], NFCForum_TS_NCI_{—}1.0.Draft 4, 2010-06-10, which describes NFC device discovery. NFC device discovery is performed by exchanging NFC radio frequency (RF) signals between NFC controllers or NFC tags, wherein each sequence of RF signals is a plurality of discovery periods, each including a poll interval, a listen interval, and an idle interval. A remote device is found only when one device is in the poll interval and the other device is in the listen interval at the same time.

In device discovery, a host device that wishes to initiate an NFC session, sends a command to its associated NFC controller to begin a sequence of discovery periods. The initiating NFC controller first performs a collision avoidance procedure by listening for other RF signals that might occur during its poll interval. If no interference is detected in the poll interval, then the initiating NFC controller begins the series of discovery periods by transmitting a query during the poll interval, which typically includes parameters identifying the technology protocol that the initiating NFC controller uses. The initiating NFC controller then enters the listening interval of its discovery period, during which it may detect any remote NFC device in the active mode that happens to be conducting device discovery and is transmitting a polling signal during its own, respective poll interval. The polling signal from a remote NFC device in the active mode will, at a minimum, indicate the presence of a responding NFC device within communication range. Typically, a polling signal from a remote NFC device will also include parameters identifying the technology protocol that the remote device uses. There is typically no initial synchronization of the discovery periods of the two NFC devices. A remote device in the active mode may be found only when the remote device is in its poll interval and the initiating device is in its listen interval at the same time.

The NFC Digital Protocol Candidate Technical Specification describes discovery as specifying the policy used by the NFC controller to execute Technology Detection and Collision Resolution for the different technologies NFC-A, NFC-B and NFC-F. Discovery is a periodic activity configured by different discovery types. The Discovery Total Duration specifies the total duration of one discovery period where all listed Discovery Types, for example NFC-A, NFC-B, and NFC-F, will be executed in the specified frequency and order in consecutive, respective poll periods during the poll interval. The total duration of one discovery period includes a poll interval and a listen interval, where the intervals are executed in the specified order. The three different technologies NFC-A, NFC-B and NFC-F, may be simultaneously detected in the listen interval. If the sum of the poll interval and the listen interval is less than Discovery Total Duration, the NFC controller will fill the gap with the idle interval, where neither poll nor listen activity will be executed. The discovery activity is configured by the host device with an NCI_CORE_SET_CONFIG_CMD command that is used to configure some of discovery parameters. The remaining discovery parameters are configured with an NCI_DISCOVER_CMD command that also starts the discovery operation by the NFC controller.

The NCI technical specification requires a rigid format for the discovery periods, limiting the timing and duration of the discovery period, the poll interval, the listen interval, and the idle interval so that listen interval of one device is rarely juxtaposed with the poll interval of another device. This imposes a relatively low probability that poll and listen intervals can be rapidly matched. This problem is especially encountered when either one of the NFC devices is a mobile device that may need to use its idle intervals for power conservation.

Example method, apparatus, and computer program product embodiments are disclosed to improve device discovery in near-field communication. Example embodiments of the invention include a wireless host device coupled to a near-field communication (NFC) controller via an NFC controller interface (NCI), the NFC controller capable of exchanging NFC radio frequency (RF) signals with other NFC controllers or with NFC tags, according to an embodiment of the present invention. In example embodiments of an NFC discovery RF signal sequence may be exchanged between two NFC controllers, each sequence of RF signals comprising a plurality of discovery periods, each including a poll interval, a listen interval, and an idle interval. Several methods are disclosed to improve the probability of detection of another NFC device by modifying the format of the discovery period.

An example format of the NFC discovery period may include specifying the duration of the discovery period, the duration of the poll interval, the duration of the listen interval, and/or the duration of the idle interval. The format of the NFC discovery period may also include specifying a periodic skipping of polling for certain NFC technologies. For example, NFC-A is polled in every discovery period, NFC-B is polled in every second discovery period, and NFC-F in every third discovery period.

Example embodiments of the invention include a wireless host device coupled to a near-field communication (NFC) controller via an NFC controller interface (NCI), the NFC controller capable of exchanging NFC radio frequency (RF) signals with other NFC controllers or with NFC tags, according to an embodiment of the present invention. In example embodiments of the invention, an NFC discovery RF signal sequence may be exchanged between two NFC controllers, each sequence of RF signals comprising a plurality of discovery periods, each including at least a poll interval. Discovery periods may also include a listen interval and/or an idle interval. For example, an NFC Reader/Writer device such as a tag reader with fixed power source, may have only polling intervals. An NFC Reader/Writer device that is battery operated may have both poll and idle intervals, but no listen intervals. A general purpose NFC device such as a mobile telephone, may have some or all of those intervals, depending on the device's mode of operation.

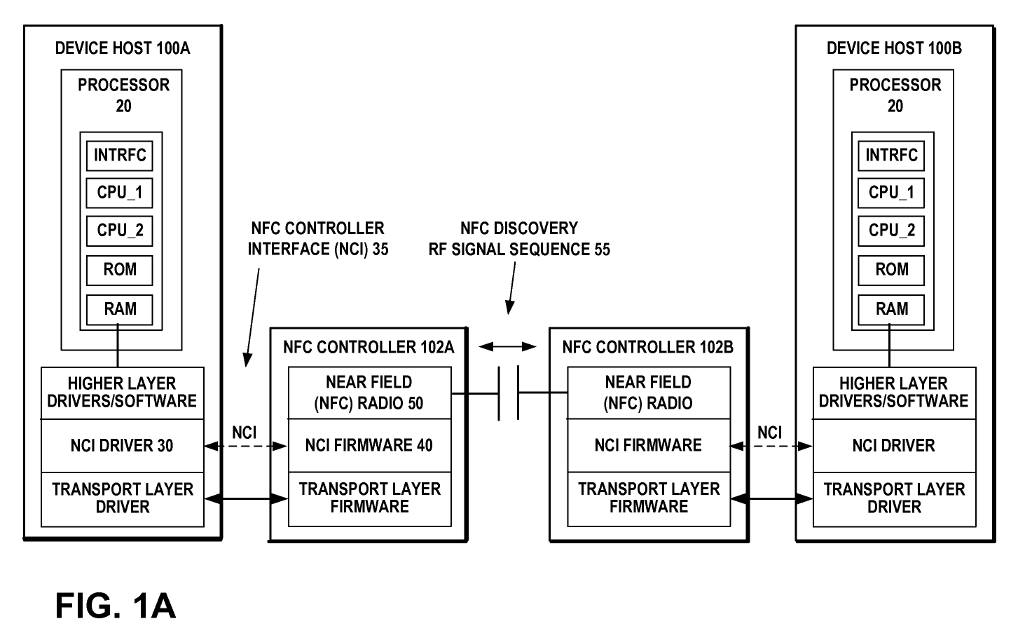

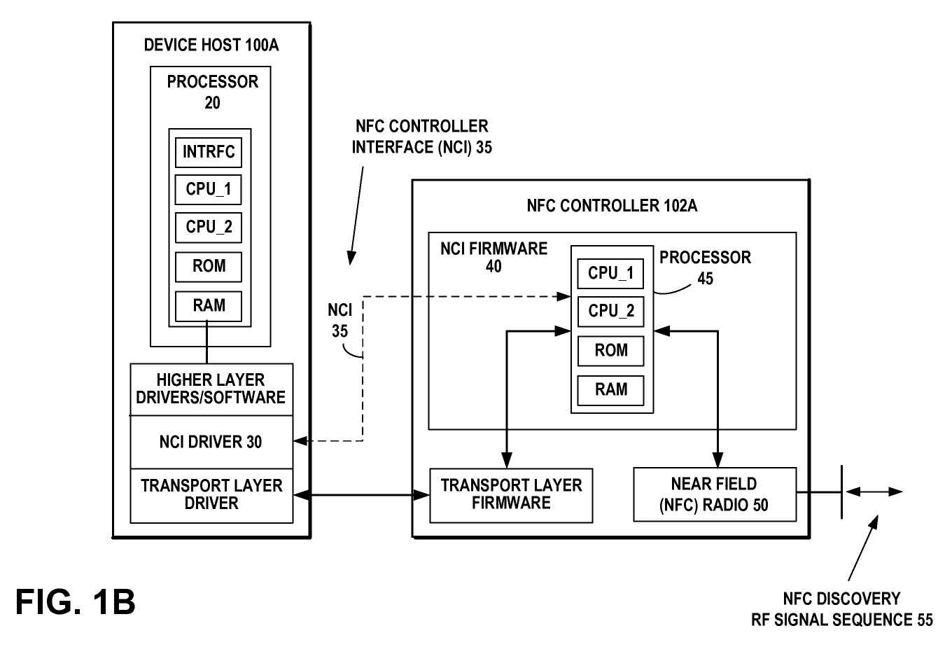

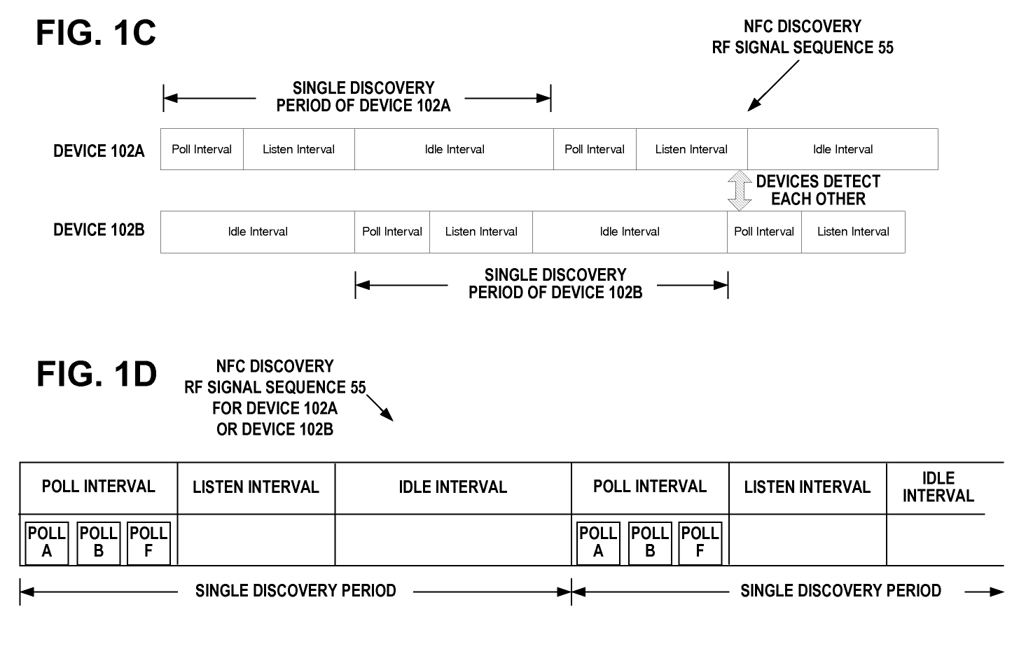

FIG. 1A is an example embodiment of a wireless network diagram of two wireless devices, each comprising a host device 100A and 100B coupled to an NFC controller 102A and 102B, respectively, via an NFC controller interface (NCI) 35. The NFC controllers 102A and 102B are capable of exchanging near-field communication (NFC) RF signals 55, according to an embodiment of the present invention. The host device 100A may request that the NFC controller 102A start discovery by sending a “discover” command. The Set command configures the TOTAL_DURATION and LISTEN_DURATION parameters, for example. The parameters Discovery Type, Discovery Frequency, and Discovery Type specific parameters are provided by the host device 100A to configure the manner in which the NFC controller 102A performs the discovery activity, if these parameters are acceptable to the NFC controller 102A. Once discovery has been started, the NFC controller 102A notifies the host device 100A of every detectable target NFC device or tag by sending a Notification with a Status and relevant parameters.

For example, the wireless host device 100A may be a communications device, PDA, cell phone, laptop or palmtop computer, or the like. The wireless device 100A includes a processor 20, which includes a dual core central processing unit (CPU_{—}1 and CPU_{—}2), a random access memory (RAM), a read only memory (ROM), and interface circuits to interface with one or more radio transceivers, battery and other power sources, key pad, touch screen, display, microphone, speakers, ear pieces, camera or other imaging devices, etc. in the host device 100A. The RAM and ROM can be removable memory devices such as smart cards, SIMs, WIMs, semiconductor memories such as RAM, ROM, PROMS, flash memory devices, etc. The NCI driver 30 in host device 100A communicates over the NFC controller interface (NCI) 35 with the NCI firmware 40 in the NFC controller 102A via the transport layer driver in host device 100A and the transport layer firmware in NFC controller 102A.

The NFC controller 102A may be embodied as hardware, software, firmware, or a combination of these constructs. It may be an integral part of the host device 100A or it my be an integrated circuit chip or card physically attached to the host device 100A, such as with a flash card adapter. FIG. 1B is an example embodiment of the NFC controller 102A, showing a more detailed view of the NCI firmware 40 in the NFC controller 102A, according to an embodiment of the present invention. For example, the NFC controller 102A includes a processor 45, which includes a dual core central processing unit (CPU_{—}1 and CPU_{—}2), a read only memory (ROM), and random access memory (RAM). The NFC controller 102A may include the NFC radio 50 or the NFC radio 50 may be separately connected. The NFC controller 102A may include its own battery or it may use power supplied by the host device 100A. The ROM and/or RAM may be a removable memory device such as a smart card, SIM, WIM, semiconductor memory such as RAM, ROM, PROMS, flash memory devices, etc.

NCI firmware 40 in the NFC controller 102A communicates bidirectionally with the NFC controller 102B via magnetic field induction, where two loop antennas are located within each other's near-field, effectively energizing a wireless contact by forming an air-core transformer. An example NFC radio 50 operates within the unlicensed radio frequency ISM band of 13.56 MHz, with a bandwidth of approximately 2 MHz over a typical distance of a few centimeters. The user may bring the NFC radio 50 on the NFC controller 102A close to the NFC controller 102B of the second host device 100B to allow near-field, bidirectional communication between the devices. NFC technology is an extension of the ISO/IEC 14443 proximity-card standard for contactless smartcards and radio frequency ID (RFID) devices, which combines the interface of a contactless smartcard and a reader into a single device, and uses the ISO/IEC 18092 NFC communication standard to enable two-way communication. An NFC radio may communicate with both existing ISO/IEC 14443 contactless smartcards and readers, as well as with other NFC devices by using ISO/IEC 18092.

When two NFC controllers 102A and 102B are brought into close proximity, they may establish NFC communication based on the NFC Forum Logical Link Control Protocol (LLCP) specification. In example embodiments of the invention, the NFC controller 102A may be a contactless smartcard reader having characteristics similar to those described in the ISO/IEC 14443 proximity-card standard, the smartcard and reader being associated or combined as a single component capable of two-way communication, and may use the ISO/IEC 18092 NFC communication standard.

FIG. 1C is an example embodiment of two NFC discovery RF signal sequences 55 exchanged between the two NFC controllers 102A and 102B of FIG. 1A, each sequence of RF signals 55 comprising a poll interval, a listen interval, and an idle interval. FIG. 1C illustrates a relatively short period during which the listen interval of one device will overlap the poll interval of the other device, illustrating a relatively low probability that the devices may rapidly detect one another.

NFC supports at least three different technologies NFC-A, NFC-B and NFC-F, and thus there may be separate poll periods for each technology in the poll interval. However, all of these technologies may be simultaneously detected in the listen interval. An example command from the host device 100A to the NFC controller 102A to initiate the discovery of targets in the field, may specify four consecutive poll periods for NFC-A, NFC-B, NFC-F, and point-to-point (P2P) in the poll interval. This may be followed by the listen interval during which polling signals may be simultaneously detected from another NFC device in any of the three technologies, NFC-A, NFC-B, or NFC-F.

FIG. 1D is an example embodiment of an NFC discovery RF signal sequence 55 exchanged between the two NFC controllers 102A and 102B of FIG. 1A, each sequence of RF signals comprising a poll interval, a listen interval, and an idle interval. The three different technologies NFC-A, NFC-B and NFC-F, may be transmitted in separate, respective poll periods for each technology in the poll interval. The format of the NFC discovery period may also include specifying a periodic skipping of polling for certain NFC technologies. For example, NFC-A is polled in every discovery period, NFC-B is polled in every second discovery period, and NFC-F in every third discovery period. The three different technologies NFC-A, NFC-B and NFC-F, may be detected simultaneously in the listen interval, according to an embodiment of the present invention.

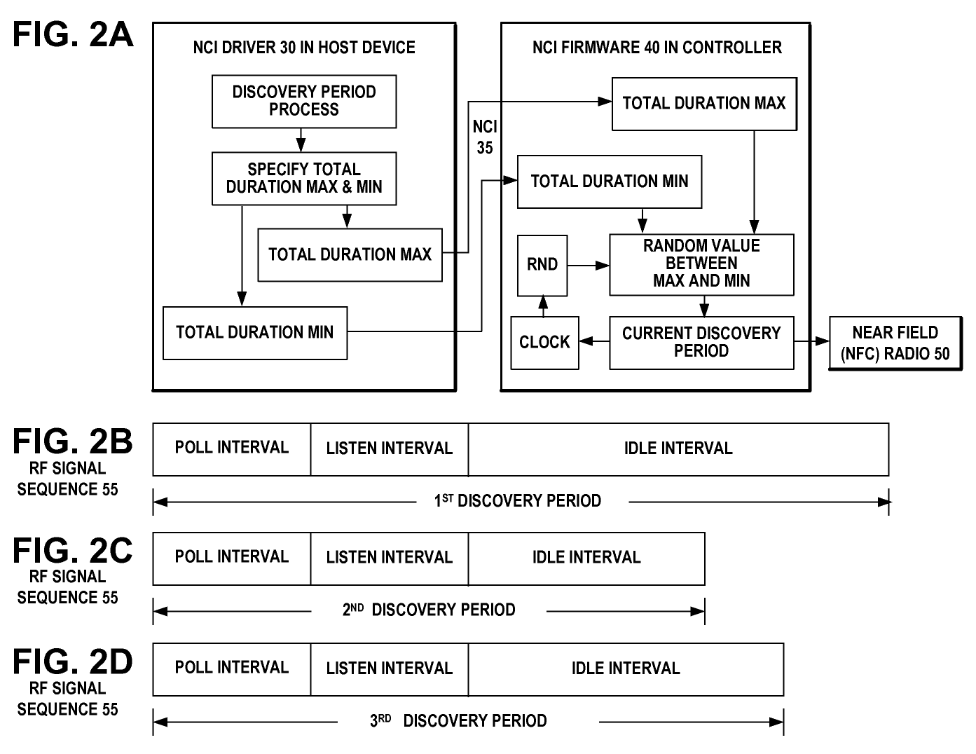

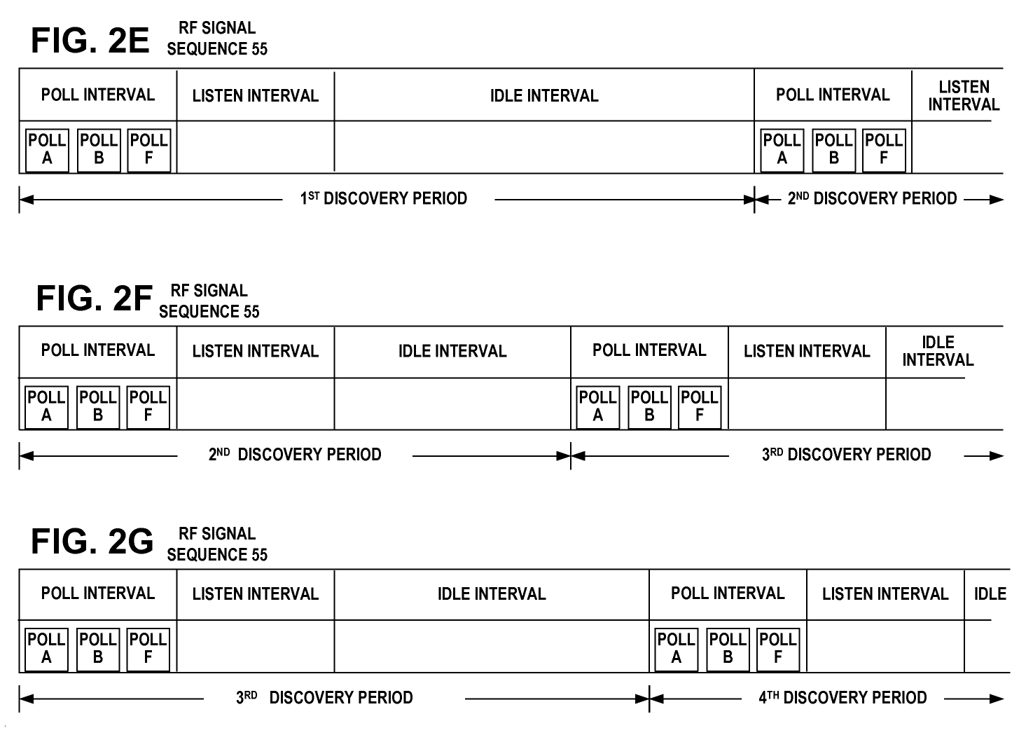

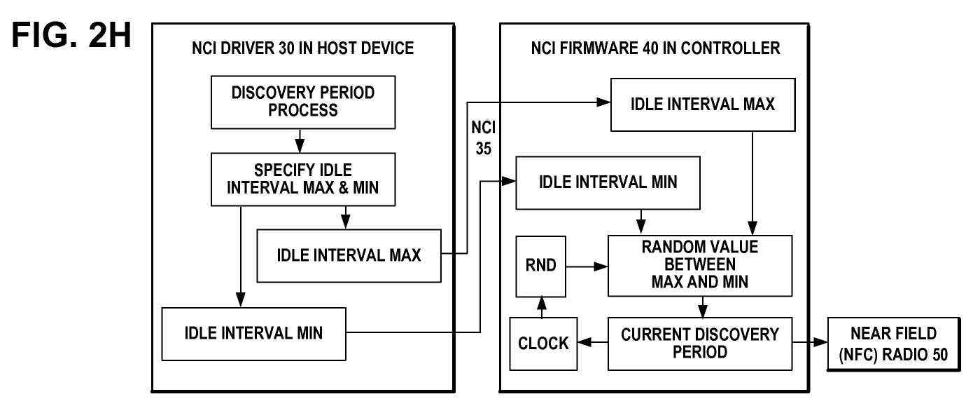

FIG. 2A discloses an example embodiment of the NFC controller interface (NCI) between an NCI driver in the host device and an NCI firmware in the NFC controller coupled to the host device, wherein the NFC controller interface (NCI) delivers from the host a maximum value and a minimum value for the total duration of the discovery period to the NFC controller, which generates in response to that, a NFC discovery RF signal sequence of random total durations of the discovery period, to increase the probability that the listen interval of one device will overlap the poll interval of the other device.

FIG. 2A is an example embodiment of the NFC controller interface (NCI) 35 between an NCI driver 30 in the host device 100A and an NCI firmware 40 in the NFC controller 102A coupled to the host device 100A of FIG. 1A or 1B. First the host 100A sends a Set command over the NFC controller interface (NCI) 35 to the NFC controller 102A to configure several discovery related parameters, including a maximum value and a minimum value for the total duration of the discovery period, as parameters for formatting an NFC discovery period to increase a probability of discovering another NFC device. Then the host device 100A sends a Discovery Start command to the NFC controller 102A with some additional parameters. The NFC controller 102A then starts discovery and generates an NFC discovery RF signal sequence 55 of random total durations of the discovery period, to increase the probability that the listen interval of one device will overlap the poll interval of the other device. The NFC controller 102A continues discovery by repeating the discovery periods until either some NFC target is found or the host device 100A explicitly stops the discovery. The randomness of the total durations increases the probability that the listen interval of one device will overlap the poll interval of the other device, enabling the two devices to more rapidly detect one another, according to an embodiment of the present invention. The random number generator RND generates pseudorandom values that are used to produce random values of the total duration of the discovery period between the maximum value and the minimum value for the total duration of the discovery period.

According to an example embodiment, the NFC controller comprises at least one processor and at least one memory including computer program code, wherein the at least one memory and the computer program code are configured to, with the at least one processor, cause the apparatus at least to:
receive a maximum value and a minimum value for a total duration of an NFC discovery period;
generate a sequence of random total durations of the NFC discovery period having values between the maximum value and the minimum value for the total duration of the NFC discovery period; and
initiate transmission of an NFC discovery RF signal having the sequence of random total durations of the NFC discovery period.

FIG. 2B is an example embodiment of the format of a first discovery period in the NFC discovery RF signal sequence 55, having a random total duration of the discovery period generated by the NFC controller 102A of FIG. 2A, according to an embodiment of the present invention.

FIG. 2C is an example embodiment of the format of a second discovery period in the NFC discovery RF signal sequence 55, having a random total duration of the discovery period generated by the NFC controller 102A of FIG. 2A, which is shorter than that shown in FIG. 2B, according to an embodiment of the present invention. The shorter total duration of the discovery period causes the listen interval to occur sooner, to increase a probability of discovering another NFC device.

FIG. 2D is an example embodiment of the format of a third discovery period in the NFC discovery RF signal sequence 55, having a random total duration of the discovery period generated by the NFC controller 102A of FIG. 2A, which is between those shown in FIGS. 2B and 2C, according to an embodiment of the present invention.

FIG. 2E is an example embodiment of the format of a first discovery period in the NFC discovery RF signal sequence, having a random total duration generated by the NFC controller of FIG. 2A, including polling for the different technologies NFC-A, NFC-B and NFC-F, according to an embodiment of the present invention.

FIG. 2F is an example embodiment of the format of a second discovery period in the NFC discovery RF signal sequence, having a random total duration generated by the NFC controller of FIG. 2A, including polling for the different technologies NFC-A, NFC-B and NFC-F, which is shorter than that shown in FIG. 2B, according to an embodiment of the present invention. The shorter total duration of the discovery period causes the listen interval to occur sooner, to increase a probability of discovering another NFC device.

FIG. 2G is an example embodiment of the format of a third discovery period in the NFC discovery RF signal sequence, having a random total duration generated by the NFC controller of FIG. 2A, including polling for the different technologies NFC-A, NFC-B and NFC-F, which is between those shown in FIGS. 2B and 2C, according to an embodiment of the present invention.

FIG. 2H discloses an example embodiment of the NFC controller interface (NCI) between an NCI driver in the host device and an NCI firmware in the NFC controller coupled to the host device, the NFC controller interface (NCI) receives from the host a maximum value and a minimum value for the idle interval of the discovery period and the NFC controller generates a NFC discovery RF signal sequence of random values for the idle interval of the discovery period, to increase the probability that the listen interval of one device will overlap the poll interval of the other device, enabling the two devices to more rapidly detect one another, according to an embodiment of the present invention.

FIG. 2H is an example embodiment of the NFC controller interface (NCI) 35 between an NCI driver 30 in the host device 100A and an NCI firmware 40 in the NFC controller 102A coupled to the host device 100A of FIG. 1A or 1B, wherein the NFC controller interface (NCI) receives from the host a Set command to configure several discovery related parameters, including a maximum value and a minimum value for the idle interval of the discovery period. The NFC controller then starts discovery and generates a NFC discovery RF signal sequence of random values for the idle interval of the discovery period, to increase the probability that the listen interval of one device will overlap the poll interval of the other device, enabling the two devices to more rapidly detect one another, according to an embodiment of the present invention. The NFC controller of FIG. 2H generates the example embodiments of the format of the discovery period shown in FIGS. 2B to 2G.

According to an example embodiment, the NFC controller comprises at least one processor and at least one memory including computer program code, wherein the at least one memory and the computer program code configured to, with the at least one processor, cause the apparatus at least to:
receive a maximum value and a minimum value for an idle interval of an NFC discovery period;
generate a sequence of random idle interval values between the maximum value and the minimum value for the idle interval of the NFC discovery period; and
initiate transmission of an NFC discovery RF signal of a plurality of NFC discovery periods each including a random idle interval value.

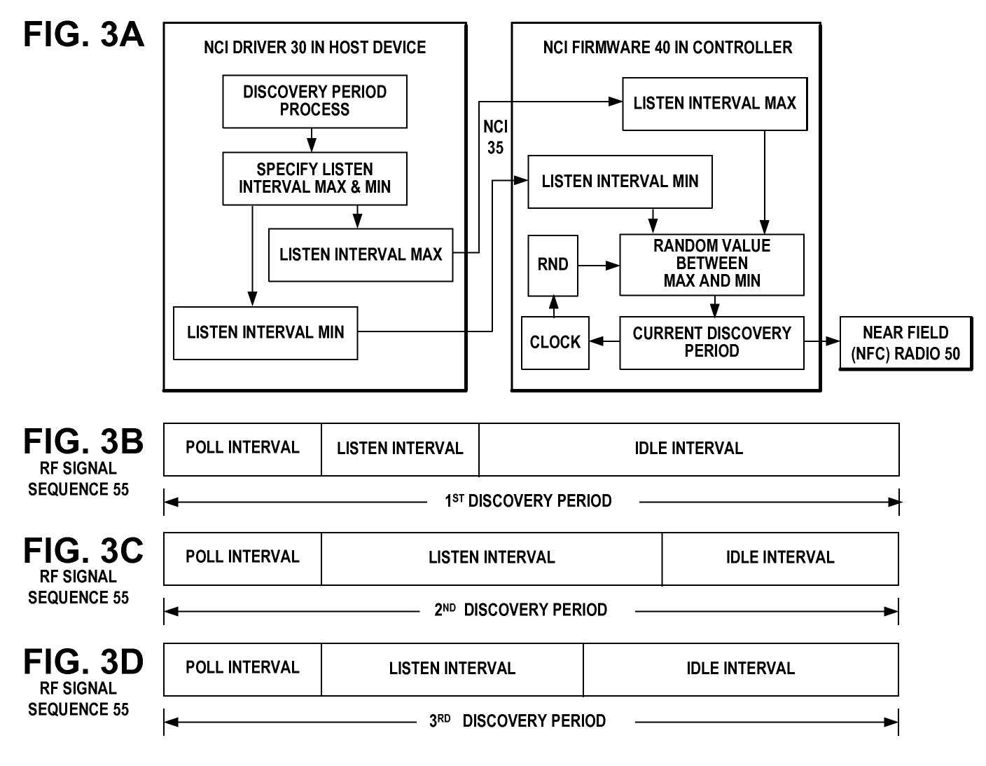

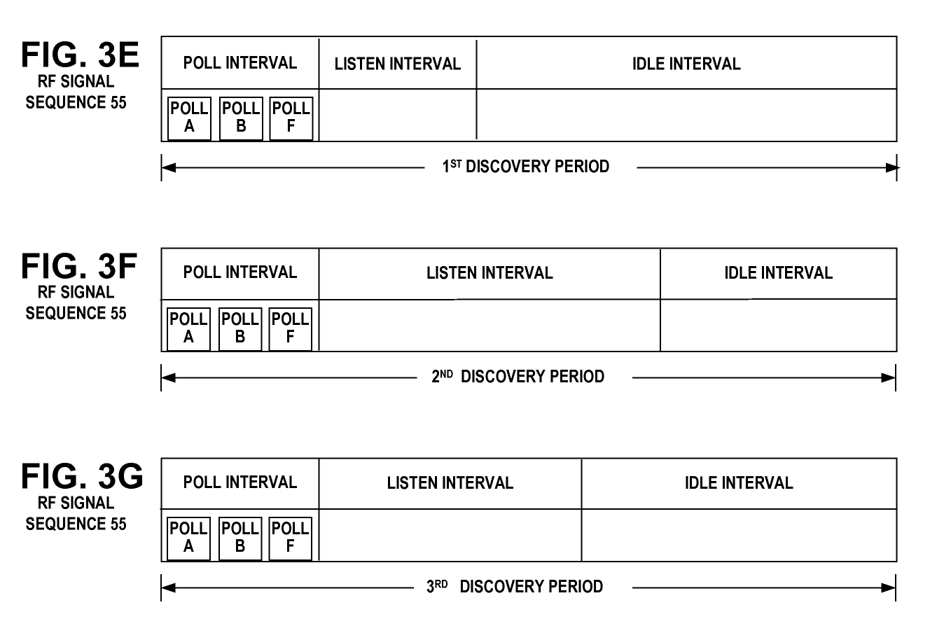

FIG. 3A discloses an example embodiment of the NFC controller interface (NCI) between an NCI driver in the host device and an NCI firmware in the NFC controller coupled to the host device, the NFC controller interface (NCI) receives from the host a maximum value and a minimum value for the listen interval of the discovery period and the NFC controller generates a NFC discovery RF signal sequence of random values for the listen interval of the discovery period, to increase the probability that the listen interval of one device will overlap the poll interval of the other device, enabling the two devices to more rapidly detect one another, according to an embodiment of the present invention.

FIG. 3A is an example embodiment of the NFC controller interface (NCI) 35 between an NCI driver 30 in the host device 100A and an NCI firmware 40 in the NFC controller 102A coupled to the host device 100A of FIG. 1A or 1B, wherein the NFC controller interface (NCI) receives from the host a Set command to configure several discovery related parameters, including a maximum value and a minimum value for the listen interval of the discovery period as parameters for formatting an NFC discovery period to increase a probability of discovering another NFC device. Then the host device 100A sends a Discovery Start command to the NFC controller 102A with some additional parameters. The NFC controller 102A then starts discovery and generates a NFC discovery RF signal sequence 55 of random values for the listen interval of the discovery period, to increase the probability that the listen interval of one device will overlap the poll interval of the other device, enabling the two devices to more rapidly detect one another, according to an embodiment of the present invention. The NFC controller 102A continues discovery by repeating the discovery periods until either some NFC target is found or the host device 100A explicitly stops the discovery.

According to an example embodiment, the NFC controller comprises at least one processor and at least one memory including computer program code, wherein the at least one memory and the computer program code configured to, with the at least one processor, cause the apparatus at least to:
receive a maximum value and a minimum value for a listen interval of an NFC discovery period;
generate a sequence of random listen interval values between the maximum value and the minimum value for the listen interval of the NFC discovery period; and
initiate transmission of an NFC discovery RF signal of a plurality of NFC discovery periods each including a random listen interval value.

FIG. 3B is an example embodiment of the format of a first discovery period in the NFC discovery RF signal sequence 55, having a random listen interval generated by the NFC controller 102A of FIG. 3A, according to an embodiment of the present invention.

FIG. 3C is an example embodiment of the format of a second discovery period in the NFC discovery RF signal sequence 55, having a random listen interval generated by the NFC controller 102A of FIG. 3A, wherein the listen interval is longer than that shown in FIG. 3B, according to an embodiment of the present invention.

FIG. 3D is an example embodiment of the format of a third discovery period in the NFC discovery RF signal sequence 55, having a random listen interval generated by the NFC controller 102A of FIG. 3A, which is between those shown in FIGS. 3B and 3C, according to an embodiment of the present invention.

FIG. 3E is an example embodiment of the format of a first discovery period in the NFC discovery RF signal sequence, having a random listen interval generated by the NFC controller of FIG. 3A, including polling for the different technologies NFC-A, NFC-B and NFC-F, according to an embodiment of the present invention.

FIG. 3F is an example embodiment of the format of a second discovery period in the NFC discovery RF signal sequence, having a random listen interval generated by the NFC controller of FIG. 3A, including polling for the different technologies NFC-A, NFC-B and NFC-F, wherein the listen interval is longer than that shown in FIG. 3B, to increase a probability of discovering another NFC device, according to an embodiment of the present invention.

FIG. 3G is an example embodiment of the format of a third discovery period in the NFC discovery RF signal sequence, having a random listen interval generated by the NFC controller of FIG. 3A, which is between those shown in FIGS. 3B and 3C, including polling for the different technologies NFC-A, NFC-B and NFC-F, according to an embodiment of the present invention.

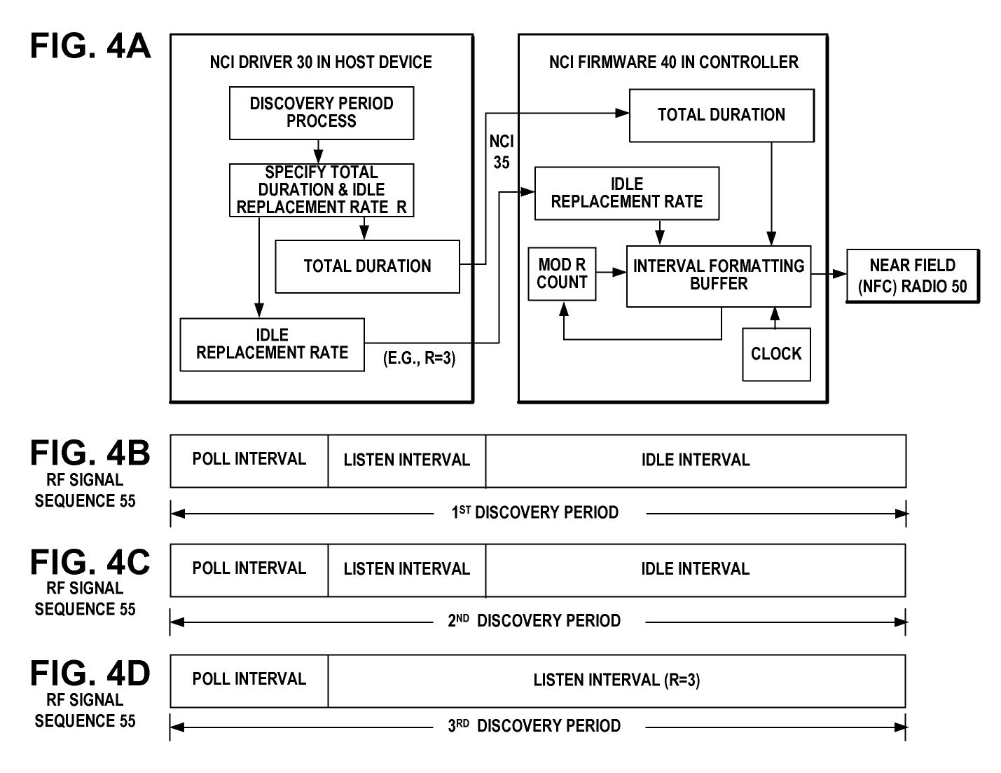

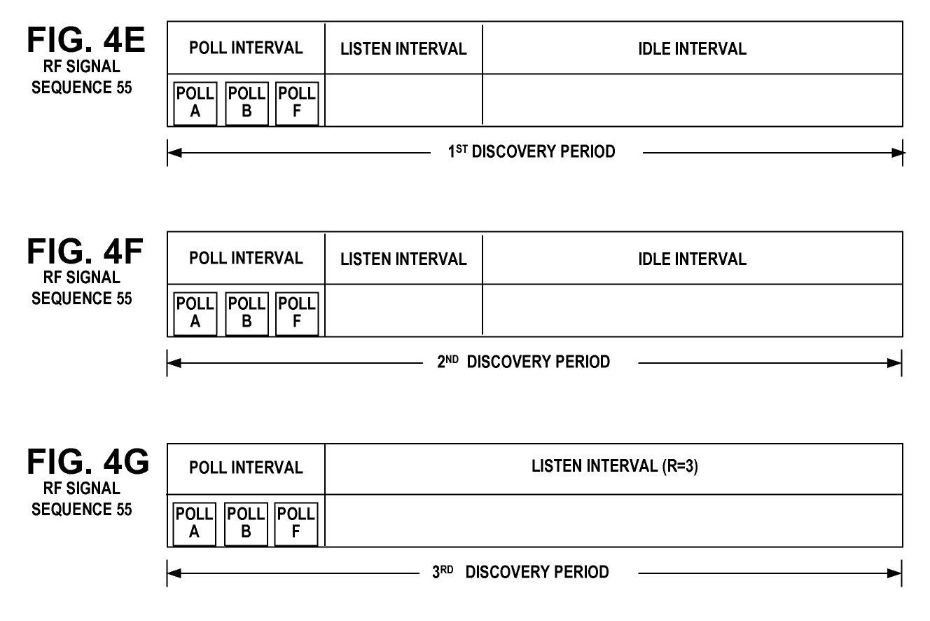

FIG. 4A discloses an example embodiment of the NFC controller interface (NCI) between an NCI driver in the host device and an NCI firmware in the NFC controller coupled to the host device, the NFC controller interface (NCI) receives from the host a value for the total duration of the discovery period and a rate at which the listen interval may be periodically expanded to include the idle interval for the total duration of one discovery period in a repeated sequence of discovery periods, to increase the probability that the listen interval of one device will overlap the poll interval of the other device, enabling the two devices to more rapidly detect one another, according to an embodiment of the present invention.

FIG. 4A is an example embodiment of the NFC controller interface (NCI) 35 between an NCI driver 30 in the host device 100A and an NCI firmware 40 in the NFC controller 102A coupled to the host device 100A of FIG. 1A or 1B, wherein the NFC controller interface (NCI) receives from the host a Set command to configure several discovery related parameters, including a value for the total duration of the discovery period and a rate “R” at which the listen interval may be periodically expanded to include the idle interval for the total duration of one discovery period in a periodically repeated sequence of discovery periods. Then the host device 100A sends a Discovery Start command (Discover CMD) to the NFC controller 102A with some additional parameters. The NFC controller then starts discovery and generates a NFC discovery RF signal sequence in which the listen interval may be periodically expanded to include the idle interval for the total duration of one discovery period in a repeated sequence of discovery periods, to increase the probability that the listen interval of one device will overlap the poll interval of the other device, enabling the two devices to more rapidly detect one another, according to an embodiment of the present invention. The modulo “R” counter in the NCI firmware 40 triggers the interval formatting buffer to expand the listen interval to include the idle interval for the total duration of one discovery period, every “R” times the discovery period is generated. FIGS. 4B, 4C, and 4D give the example operation for a value of “R” of “3”. The NFC controller 102A continues discovery by repeating the discovery periods until either some NFC target is found or the host device 100A explicitly stops the discovery.

According to an example embodiment, the NFC controller comprises at least one processor and at least one memory including computer program code, wherein the at least one memory and the computer program code configured to, with the at least one processor, cause the apparatus at least to:
receive an idle interval replacement value for a periodic replacement of an idle interval by a listen interval of an NFC discovery period;
periodically replace the idle interval with the listen interval of the NFC discovery period, the replacing being at a rate corresponding to the replacement value; and
initiate transmission of an NFC discovery RF signal of a plurality of NFC discovery periods, including a periodic NFC discovery period wherein the idle interval is replaced with the listen interval.

FIG. 4B is an example embodiment of the format of a first discovery period in the NFC discovery RF signal sequence 55, having a total duration with a normal listen interval and idle interval generated by the NFC controller 102A of FIG. 4A, according to an embodiment of the present invention.

FIG. 4C is an example embodiment of the format of a second discovery period in the NFC discovery RF signal sequence 55, having a total duration with a normal listen interval and idle interval generated by the NFC controller 102A of FIG. 4A, according to an embodiment of the present invention.

FIG. 4D is an example embodiment of the format of a third discovery period in the NFC discovery RF signal sequence 55, having a total duration in which the listen interval may be periodically expanded to include the idle interval for the total duration of one discovery period generated by the NFC controller 102A of FIG. 4A, to increase a probability of discovering another NFC device, according to an embodiment of the present invention.

FIG. 4E is an example embodiment of the format of a first discovery period in the NFC discovery RF signal sequence, having a total duration with a normal listen interval and idle interval generated by the NFC controller of FIG. 4A, including polling for the different technologies NFC-A, NFC-B and NFC-F, according to an embodiment of the present invention.

FIG. 4F is an example embodiment of the format of a second discovery period in the NFC discovery RF signal sequence, having a total duration with a normal listen interval and idle interval generated by the NFC controller of FIG. 4A, including polling for the different technologies NFC-A, NFC-B and NFC-F, according to an embodiment of the present invention.

FIG. 4G is an example embodiment of the format of a third discovery period in the NFC discovery RF signal sequence, having a total duration in which the listen interval may be periodically expanded to include the idle interval for the total duration of one discovery period generated by the NFC controller of FIG. 4A, to increase a probability of discovering another NFC device, including polling for the different technologies NFC-A, NFC-B and NFC-F, according to an embodiment of the present invention.

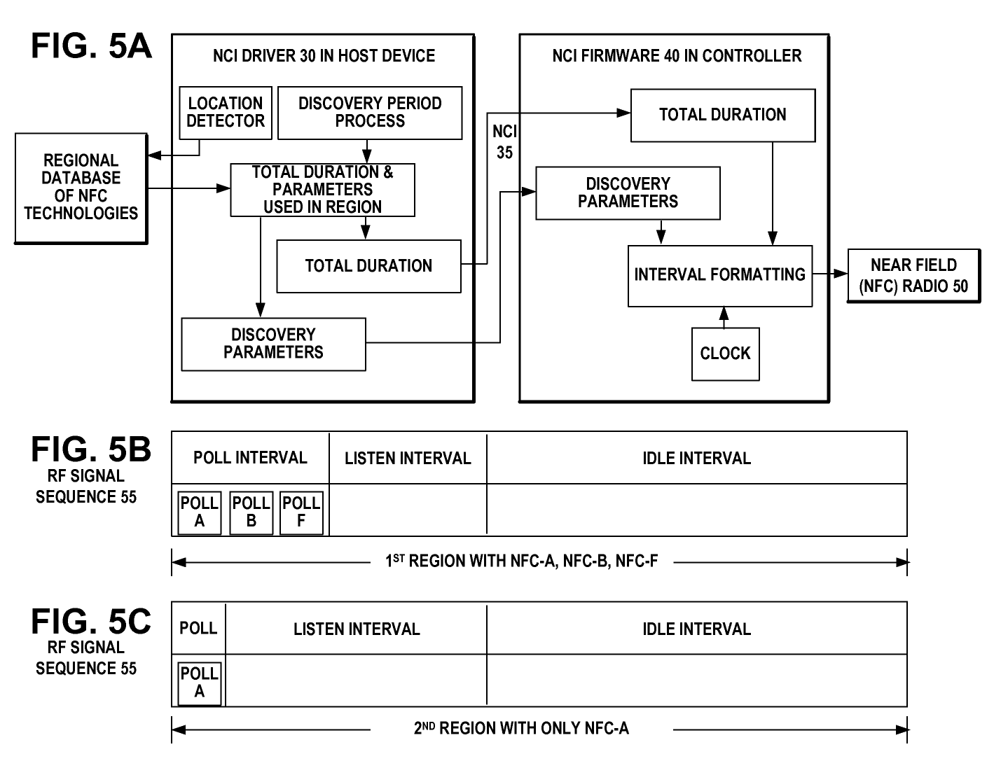

FIG. 5A discloses an example embodiment of the NFC controller interface (NCI) between an NCI driver in the host device and an NCI firmware in the NFC controller coupled to the host device, the host device accesses a regional database to determine if there are certain NFC technologies that are not in use locally and then only providing discovery parameters for those NFC technologies being used in the local region, to reduce unnecessary polling and enable longer listening intervals with the same power consumption, to increase the probability that the listen interval of one device will overlap the poll interval of the other device, enabling the two devices to more rapidly detect one another, according to an embodiment of the present invention.

FIG. 5A is an example embodiment of the NFC controller interface (NCI) 35 between an NCI driver 30 in the host device 100A and an NCI firmware 40 in the NFC controller 102A coupled to the host device 100A of FIG. 1A or 1B, wherein the host device 100A accesses a regional database of NFC technologies, for example, NFC-A, NFC-B, and/or NFC-F, to determine if there are certain NFC technologies that are not in use locally. For example, the NFC-F technology is primarily used in electronic money cards in Japan. The host device then sends to the NFC controller interface (NCI) a Set command to configure several discovery related parameters, but excluding discovery parameters for those NFC technologies that are not being used in the local region. Then the host device 100A sends a Discovery Start command to the NFC controller 102A with some additional parameters. The NFC controller then starts discovery and generates a NFC discovery RF signal sequence for only those NFC technologies that are being used in the local region, to reduce unnecessary polling and enable longer listening intervals with the same power consumption. This will increase the probability that the listen interval of one device will overlap the poll interval of the other device, enabling the two devices to more rapidly detect one another, according to an embodiment of the present invention. The NFC controller 102A continues discovery by repeating the discovery periods until either some NFC target is found or the host device 100A explicitly stops the discovery.

According to an example embodiment, the host device comprises at least one processor and at least one memory including computer program code, wherein the at least one memory and the computer program code configured to, with the at least one processor, cause the apparatus at least to:
access a regional database to determine if there are certain NFC technologies that are not in use locally; and
provide to an NFC controller discovery parameters for those NFC technologies being used in the local region, to reduce unnecessary polling and enable longer listening intervals in NFC discovery.

Optionally, example embodiments of the invention may include a location detector in the host device 100A, to detect the current geographic location of the host device 100A and send the location information to the regional database of NFC technologies, to determine if there are certain NFC technologies that are not in use locally. Examples of the optional location detector may be a Global Positioning System (GPS) receiver, an Assisted Global Navigation Satellite Systems (A-GNSS) receiver, a GSM localization module, or the like. Optionally, the communication link between the host device 100A and the regional database of NFC technologies may be a wireless link or a wireline link to the database. Alternately, the regional database of NFC technologies my be incorporated in whole or in part in the host device 100A.

FIG. 5B is an example embodiment of the format of a discovery period in the NFC discovery RF signal sequence in a first region with NFC-A, NFC-B, and NFC-F, generated by the NFC controller of FIG. 5A, according to an embodiment of the present invention.

FIG. 5C is an example embodiment of the format of a second discovery period in the NFC discovery RF signal sequence in a second region with only NFC-A, generated by the NFC controller of FIG. 5A, according to an embodiment of the present invention. Since the NFC-B, and NFC-F polls are removed from the poll interval as not being necessary in the second region, the listen interval is expanded into the reduced area of the poll interval, thereby increasing the probability that the listen interval of one device will overlap the poll interval of the other device.

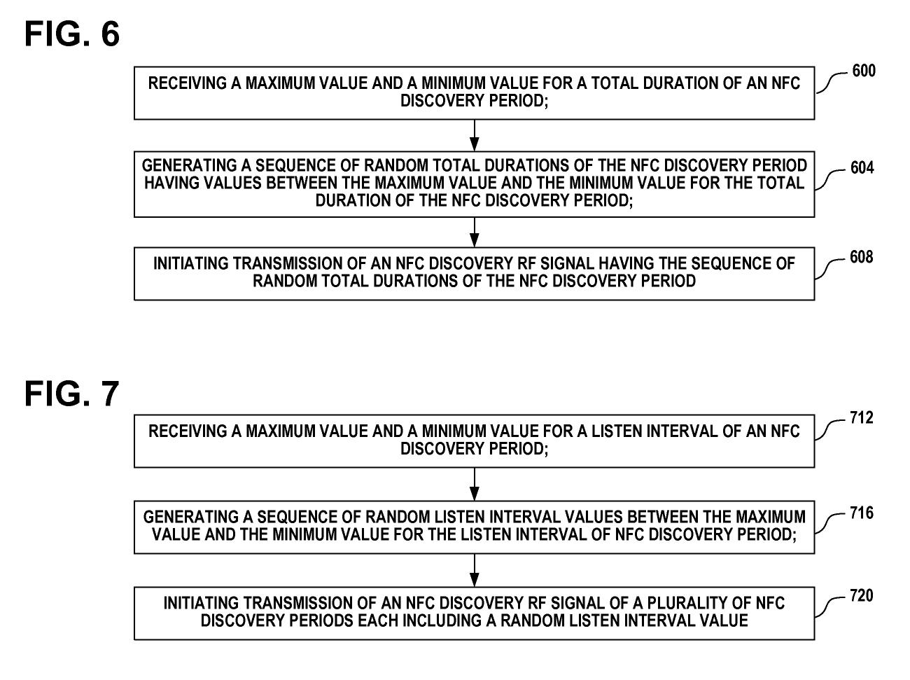

FIG. 6 discloses an example embodiment, a sequence of method steps is carried out by the NFC controller, for generating a sequence of random total durations of the NFC discovery period having values between the maximum value and the minimum value for the total duration of the NFC discovery period, according to an embodiment of the present invention. The example steps comprise:
receiving a maximum value and a minimum value for a total duration of an NFC discovery period;
generating a sequence of random total durations of the NFC discovery period having values between the maximum value and the minimum value for the total duration of the NFC discovery period; and
initiating transmission of an NFC discovery RF signal having the sequence of random total durations of the NFC discovery period.

In an example embodiment, a computer readable medium storing program instructions, which when executed by a computer processor, performs the immediately preceding method steps.

FIG. 6 is an example embodiment of a flow diagram of operational steps of an example embodiment of the method carried out between the NCI driver 30 in the host device 100A and the NCI firmware 40 in the NFC controller 102A of FIG. 2A, from the point of view of the NFC controller 102A, for generating a sequence of random total durations of the NFC discovery period having values between the maximum value and the minimum value for the total duration of the NFC discovery period, according to an embodiment of the present invention. The steps of the flow diagram represent computer code instructions stored in the RAM and/or ROM memory of the NFC controller 102A, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 600: receiving a maximum value and a minimum value for a total duration of an NFC discovery period;

Step 604: generating a sequence of random total durations of the NFC discovery period having values between the maximum value and the minimum value for the total duration of the NFC discovery period; and

Step 608: initiating transmission of an NFC discovery RF signal having the sequence of random total durations of the NFC discovery period.

FIG. 7 discloses an example embodiment, a sequence of method steps is carried out by the NFC controller, for generating a sequence of random listen interval values between the maximum value and the minimum value for the listen interval of the NFC discovery period, according to an embodiment of the present invention. The example steps comprise:
receiving a maximum value and a minimum value for a listen interval of an NFC discovery period;
generating a sequence of random listen interval values between the maximum value and the minimum value for the listen interval of the NFC discovery period; and
initiating transmission of an NFC discovery RF signal of a plurality of NFC discovery periods each including a random listen interval value.

In an example embodiment, a computer readable medium storing program instructions, which when executed by a computer processor, performs the immediately preceding method steps.

FIG. 7 is an example embodiment of a flow diagram of operational steps of an example embodiment of the method carried out between the NCI driver 30 in the host device 100A and the NCI firmware 40 in the NFC controller 102A of FIG. 3A, from the point of view of the NFC controller 102A, for generating a sequence of random listen interval values between the maximum value and the minimum value for the listen interval of the NFC discovery period, according to an embodiment of the present invention. The steps of the flow diagram represent computer code instructions stored in the RAM and/or ROM memory of the NFC controller 102A, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 712: receiving a maximum value and a minimum value for an listen interval of an NFC discovery period;

Step 716: generating a sequence of random listen interval values between the maximum value and the minimum value for the listen interval of the NFC discovery period; and

Step 720: initiating transmission of an NFC discovery RF signal of a plurality of NFC discovery periods each including a random listen interval value.

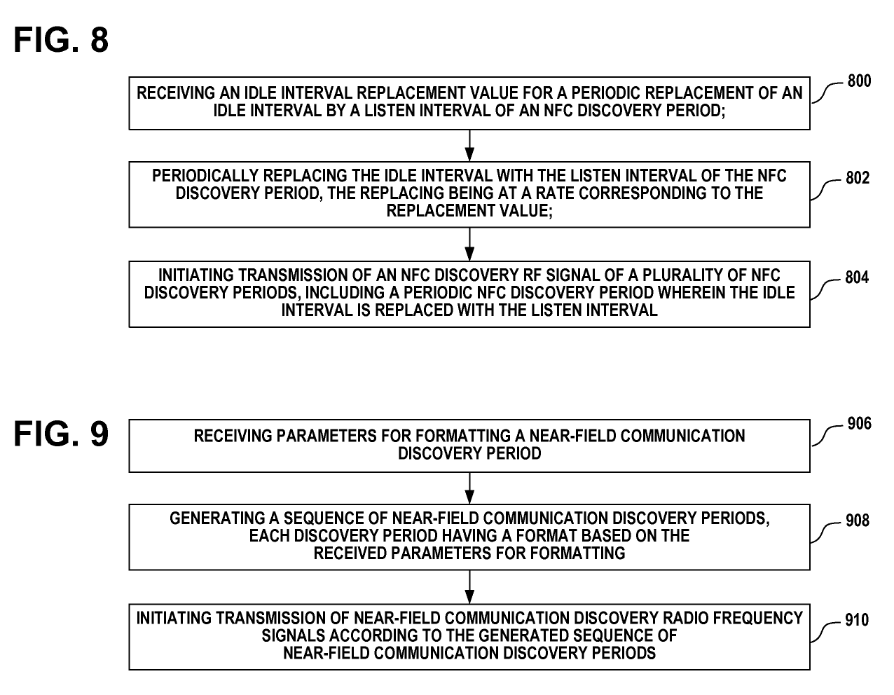

FIG. 8 discloses an example embodiment, a sequence of method steps is carried out by the NFC controller, for periodically replacing the idle interval with the listen interval of the NFC discovery period, the replacing being at a rate corresponding to the replacement value, according to an embodiment of the present invention. The example steps comprise:
receiving an idle interval replacement value for a periodic replacement of an idle interval by a listen interval of an NFC discovery period;
periodically replacing the idle interval with the listen interval of the NFC discovery period, the replacing being at a rate corresponding to the replacement value; and
initiating transmission of an NFC discovery RF signal of a plurality of NFC discovery periods, including a periodic NFC discovery period wherein the idle interval is replaced with the listen interval.

In an example embodiment, a computer readable medium storing program instructions, which when executed by a computer processor, performs the immediately preceding method steps.

FIG. 8 is an example embodiment of a flow diagram of operational steps of an example embodiment of the method carried out between the NCI driver 30 in the host device 100A and the NCI firmware 40 in the NFC controller 102A of FIG. 4A, from the point of view of the NFC controller 102A, for periodically replacing the idle interval with the listen interval of the NFC discovery period, the replacing being at a rate corresponding to the replacement value, according to an embodiment of the present invention. The steps of the flow diagram represent computer code instructions stored in the RAM and/or ROM memory of the NFC controller 102A, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 800: receiving an idle interval replacement value for a periodic replacement of an idle interval by a listen interval of an NFC discovery period;

Step 802: periodically replacing the idle interval with the listen interval of the NFC discovery period, the replacing being at a rate corresponding to the replacement value; and

Step 804: initiating transmission of an NFC discovery RF signal of a plurality of NFC discovery periods, including a periodic NFC discovery period wherein the idle interval is replaced with the listen interval.

FIG. 9 discloses an example embodiment, wherein a sequence of method steps is carried out by generating a sequence of NFC discovery periods, each discovery period having a format based on parameters for formatting to increase a probability of discovering another NFC device, according to an embodiment of the present invention. The example steps comprise:
receiving parameters for formatting a near-field communication discovery period;
generating a sequence of near-field communication discovery periods, each discovery period having a format based on the received parameters for formatting; and
initiating transmission of a near-field communication discovery RF signal according to the generated sequence of near-field communication discovery periods.

FIG. 9 is an example embodiment of a flow diagram of operational steps of an example embodiment of the method carried out between the NCI driver in the host device and the NCI firmware in the NFC controller of FIG. 2A, 2H, 3A, or 4A, from the point of view of the NFC controller, for generating a sequence of NFC discovery periods, each discovery period having a format based on parameters for formatting to increase a probability of discovering another NFC device, according to an embodiment of the present invention. An example format of the NFC discovery period may include specifying the duration of the discovery period, the duration of the poll interval, the duration of the listen interval, and/or the duration of the idle interval. The format of the NFC discovery period may also include specifying a periodic skipping of polling for certain NFC technologies. The steps of the flow diagram represent computer code instructions stored in the RAM and/or ROM memory of the NFC controller 102A, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 906: receiving parameters for formatting an NFC discovery period to increase a probability of discovering another NFC device;

Step 908: generating a sequence of NFC discovery periods, each discovery period having a format based on the parameters for formatting; and

Step 910: initiating transmission near-field communication discovery radio frequency signals according to the generated sequence of near-field communication discovery periods.

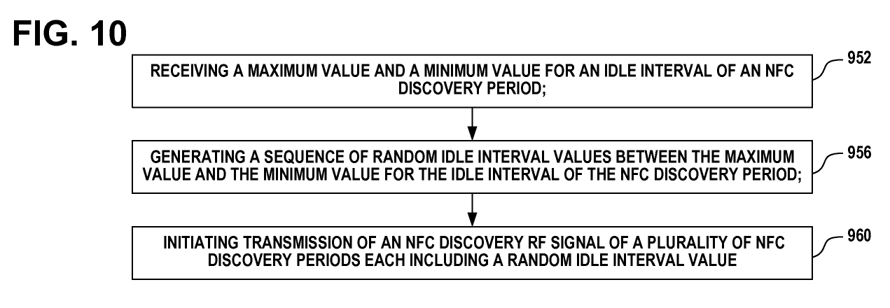

FIG. 10 discloses an example embodiment, a sequence of method steps is carried out by the NFC controller, for generating a sequence of random idle interval values between the maximum value and the minimum value for the idle interval of the NFC discovery period, according to an embodiment of the present invention. The example steps comprise:
receiving a maximum value and a minimum value for an idle interval of an NFC discovery period;
generating a sequence of random idle interval values between the maximum value and the minimum value for the idle interval of the NFC discovery period; and
initiating transmission of an NFC discovery RF signal of a plurality of NFC discovery periods each including a random idle interval value.

In an example embodiment, a computer readable medium storing program instructions, which when executed by a computer processor, performs the immediately preceding method steps.

FIG. 10 is an example embodiment of a flow diagram of operational steps of an example embodiment of the method carried out between the NCI driver 30 in the host device 100A and the NCI firmware 40 in the NFC controller 102A of FIG. 2H, from the point of view of the NFC controller 102A, for generating a sequence of random idle interval values between the maximum value and the minimum value for the idle interval of the NFC discovery period, according to an embodiment of the present invention. The steps of the flow diagram represent computer code instructions stored in the RAM and/or ROM memory of the NFC controller 102A, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 952: receiving a maximum value and a minimum value for an idle interval of an NFC discovery period;

Step 956: generating a sequence of random idle interval values between the maximum value and the minimum value for the idle interval of the NFC discovery period; and

Step 960: initiating transmission of an NFC discovery RF signal of a plurality of NFC discovery periods each including a random idle interval value.

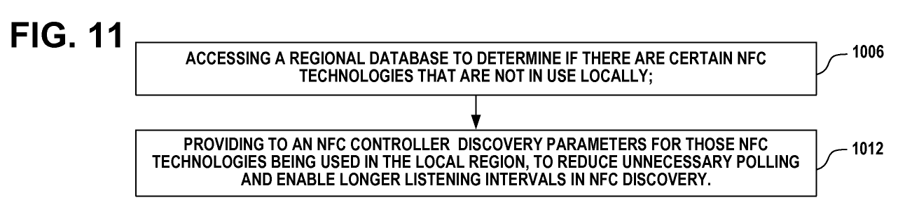

FIG. 11 discloses is an example embodiment, a sequence of method steps is carried out by the host device, for providing to an NFC controller discovery parameters for those NFC technologies being used in the local region, to reduce unnecessary polling and enable longer listening intervals in NFC discovery, according to an embodiment of the present invention. The example steps comprise:
accessing a regional database to determine if there are certain NFC technologies that are not in use locally; and
providing to an NFC controller discovery parameters for those NFC technologies being used in the local region, to reduce unnecessary polling and enable longer listening intervals in NFC discovery.

In an example embodiment, a computer readable medium storing program instructions, which when executed by a computer processor, may perform the immediately preceding method steps.

FIG. 11 is an example embodiment of a flow diagram of operational steps of an example embodiment of the method carried out between the NCI driver 30 in the host device 100A and the NCI firmware 40 in the NFC controller 102A of FIG. 5A, from the point of view of the host device 100A, for providing to an NFC controller 102A discovery parameters for those NFC technologies being used in the local region, to reduce unnecessary polling and enable longer listening intervals in NFC discovery, according to an embodiment of the present invention. The steps of the flow diagram represent computer code instructions stored in the RAM and/or ROM memory of the host device 100A, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 1006: accessing a regional database to determine if there are certain NFC technologies that are not in use locally; and

Step 1012: providing to an NFC controller discovery parameters for those NFC technologies being used in the local region, to reduce unnecessary polling and enable longer listening intervals in NFC discovery.

In example embodiments of the invention, the method of FIG. 11 may further comprise sending to the near-field communication controller, a command to initiate generation of a sequence of near-field communication discovery periods, each discovery period having a format based on the provided discovery parameters, if a change in an ambient condition has been detected. The ambient condition may be an ambient light level detected to be greater than a predetermined threshold. Alternately or in combination with the light level detection, the ambient condition may be an acceleration level detected to be greater than a predetermined threshold.

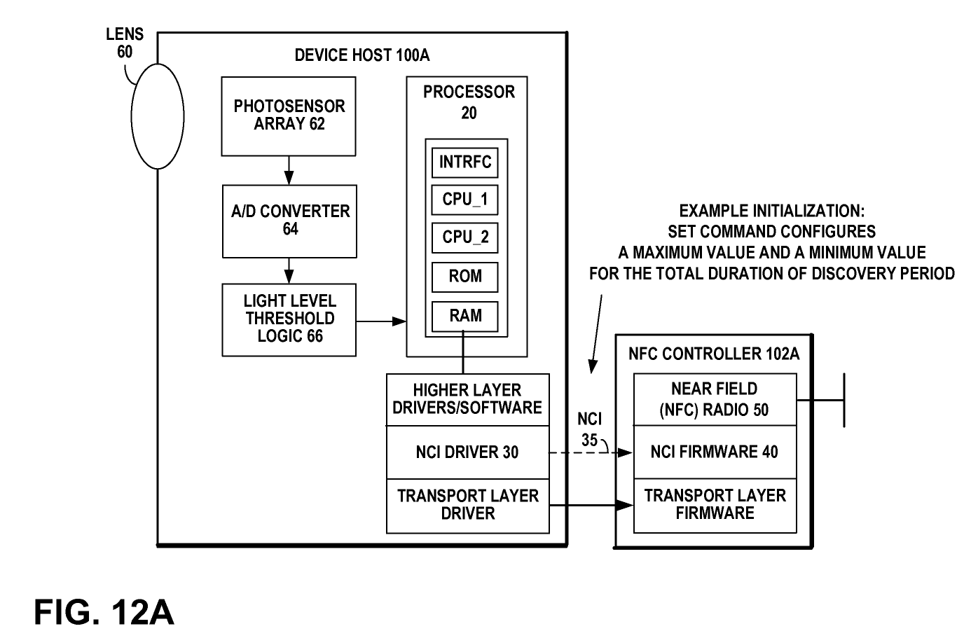

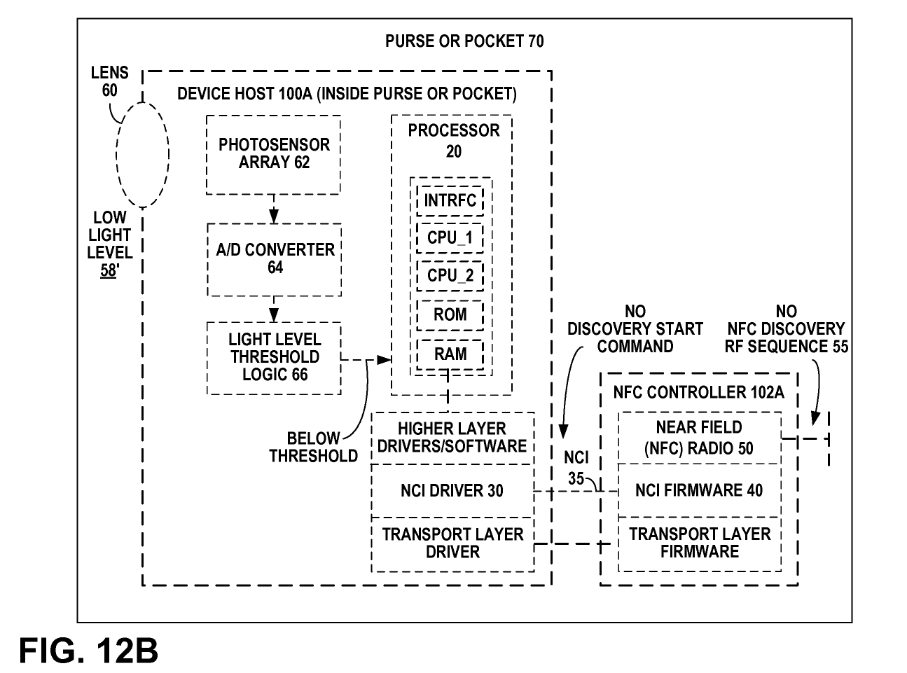

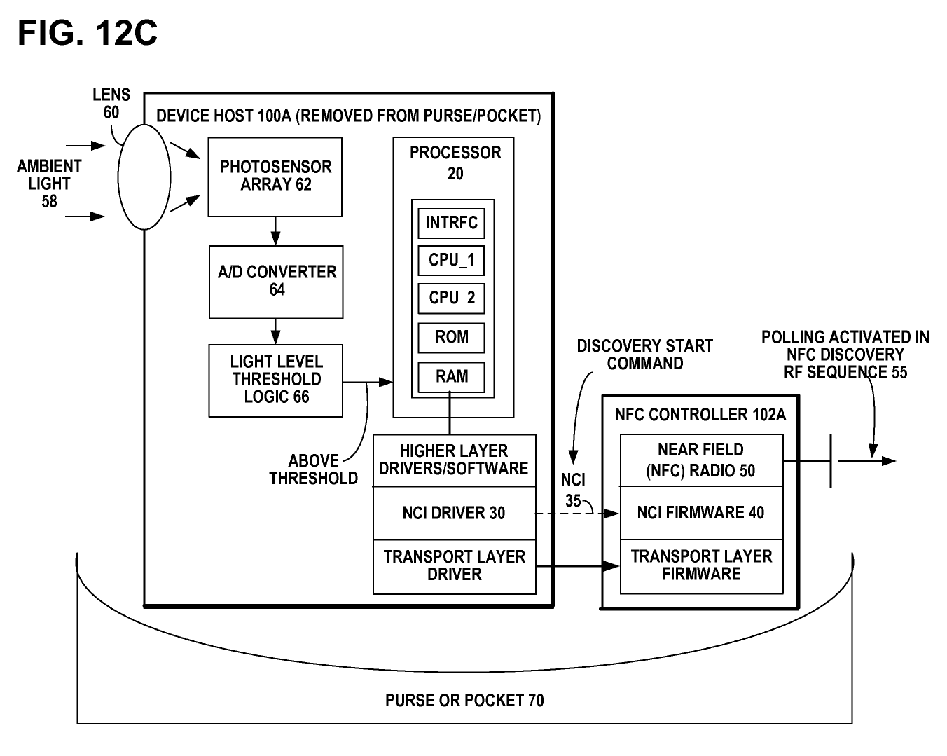

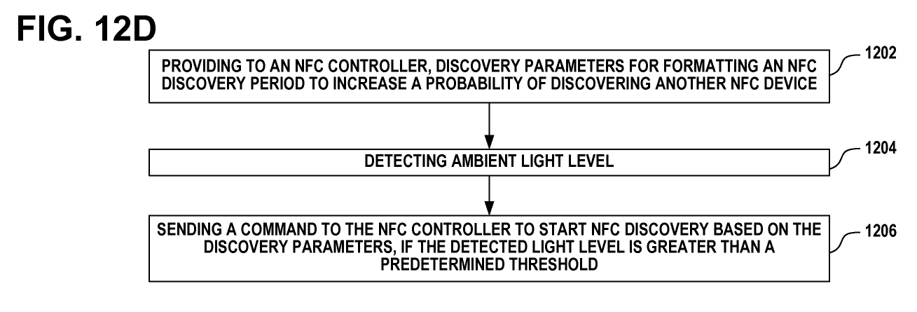

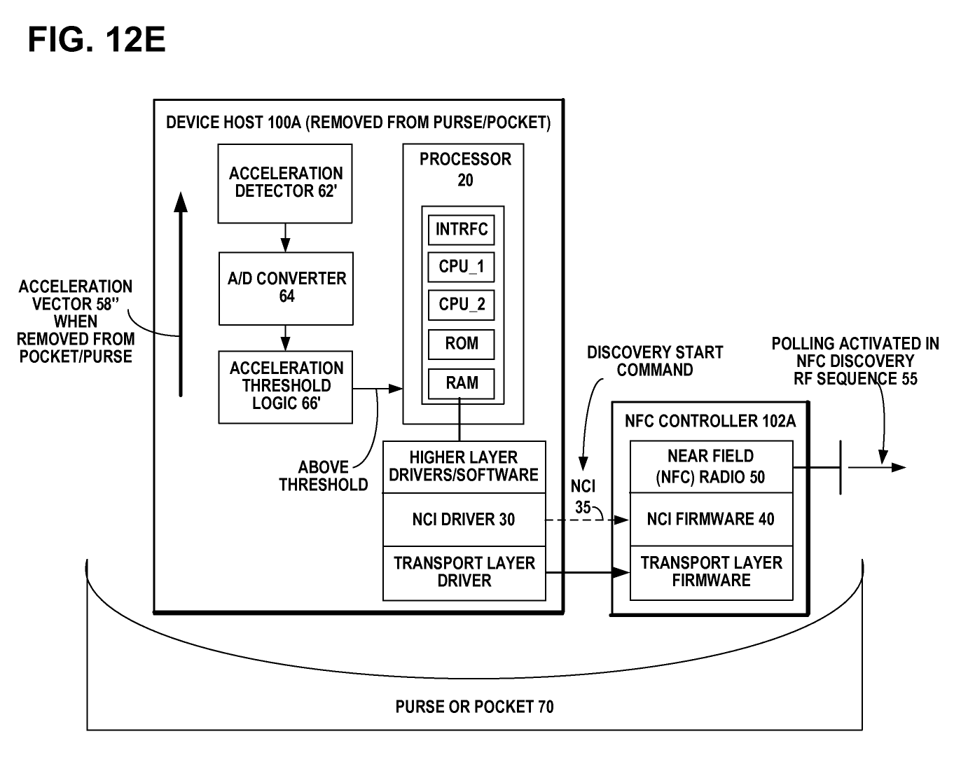

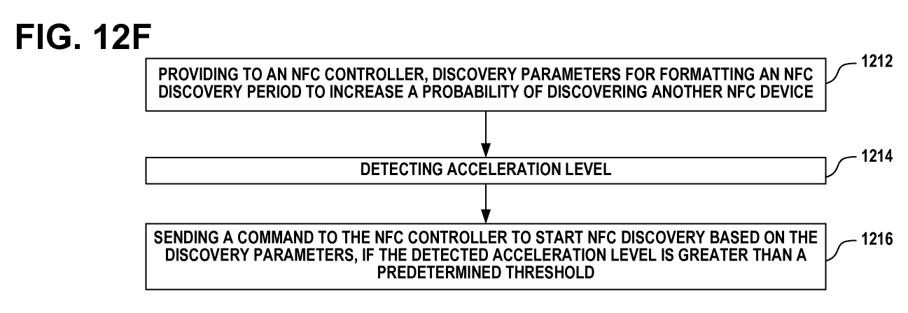

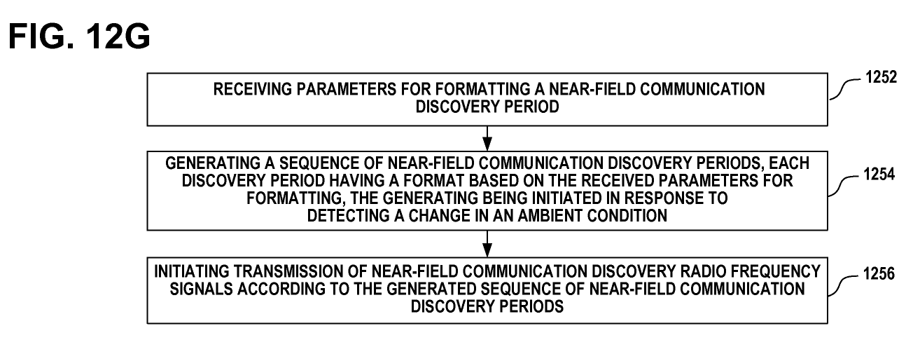

FIG. 12A is an example embodiment of the wireless host device 100A coupled to the NFC controller 102A via the NFC controller interface (NCI) 35, similar to that shown in FIG. 1B, wherein the host device is shown performing an example initialization by sending to the NFC controller a Set command with discovery parameters for formatting an NFC discovery period to increase a probability of discovering another NFC device. The example initialization shown is a Set command that configures a maximum value and a minimum value for the total duration of discovery period. FIG. 12A further shows an ambient light detection subsystem including the lens 60, photosensor array 62, analog to digital (A/D) converter 64, and light level threshold logic 66 that may be used to trigger the processor 20 in the host device 100A to send a Discovery Start command (Discover CMD) to the NFC controller 102A when the ambient light level is determined to be greater than a predetermined threshold, according to an embodiment of the present invention.

According to an example embodiment, the host device comprises at least one processor, at least one memory including computer program code and an ambient light detector coupled to the processor, wherein the at least one memory and the computer program code configured to, with the at least one processor, cause the apparatus at least to:
provide to an NFC controller, discovery parameters for formatting an NFC discovery period to increase a probability of discovering another NFC device;
detect ambient light level; and
send a command to the NFC controller to initiate NFC discovery based on the discovery parameters, if the detected light level is greater than a predetermined threshold.

FIG. 12B is an example embodiment of the wireless host device coupled to the NFC controller via the NFC controller interface (NCI) of FIG. 12A, wherein the host device 100A and the NFC controller 102A are enclosed in a pocket or purse 70 where there is a low light level 58′ causing the ambient light detection subsystem 60, 62, 64, and 66 and the processor 20 in the host device 100A to determine that the ambient light level 58′ is less than the predetermined threshold, resulting in the host device 100A withholding sending a Discovery Start command to the NFC controller 102A, according to an embodiment of the present invention.

FIG. 12C is an example embodiment of the wireless host device coupled to the NFC controller via the NFC controller interface (NCI) of FIGS. 12A and 12B, wherein the host device 100A and the NFC controller 102A are withdrawn from the pocket or purse 70 and into a higher light level of ambient light 58 causing the ambient light detection subsystem 60, 62, 64, and 66 and the processor 20 in the host device 100A to determine that the ambient light level is greater than the predetermined threshold, resulting in the host device 100A sending a Discovery Start command to the NFC controller 102A to activate NFC polling based on the discovery parameters, according to an embodiment of the present invention.

FIG. 12D is an example embodiment, a sequence of method steps is carried out by the host device, for initializing the NFC controller by providing discovery parameters for formatting an NFC discovery period to increase a probability of discovering another NFC device. If the host device and the NFC controller are enclosed in a pocket or purse where there is a low light level, an ambient light detection subsystem and the host device determine that the ambient light level is less than a predetermined threshold, resulting in the host device withholding sending a start discovery command to the NFC controller. When the host device and the NFC controller are withdrawn from the pocket or purse and into a higher light level, the ambient light detection subsystem and host device determine that the ambient light level is greater than the predetermined threshold, resulting in the host device sending a start discovery command to the NFC controller to activate NFC polling based on the discovery parameters, according to an embodiment of the present invention. The example steps comprise:

providing to an NFC controller, discovery parameters for formatting an NFC discovery period to increase a probability of discovering another NFC device;

detecting ambient light level; and

sending a command to the NFC controller to initiate NFC discovery based on the discovery parameters, if the detected light level is greater than a predetermined threshold.

In an example embodiment, a computer readable medium storing program instructions, which when executed by a computer processor, performs the immediately preceding method steps.

FIG. 12D is an example embodiment of a flow diagram of operational steps of an example embodiment of the method carried out between the host device and the NFC controller of FIGS. 12A-12C, from the point of view of the host device 100A, for initializing the NFC controller 102A by sending a Set command with discovery parameters for formatting an NFC discovery period to increase a probability of discovering another NFC device, detecting an ambient light level, and sending a command to the NFC controller to start NFC discovery based on the discovery parameters, if the detected light level is greater than a predetermined threshold, according to an embodiment of the present invention. The steps of the flow diagram represent computer code instructions stored in the RAM and/or ROM memory of the host device 100A, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 1202: providing to an NFC controller, discovery parameters for formatting an NFC discovery period to increase a probability of discovering another NFC device.

Step 1204: detecting ambient light level.

Step 1206: sending a command to the NFC controller to initiate NFC discovery based on the discovery parameters, if the detected light level is greater than a predetermined threshold.

FIG. 12E is an example embodiment of the wireless host device coupled to the NFC controller via the NFC controller interface (NCI) of FIGS. 12A and 12B, wherein the host device 100A and the NFC controller 102A are withdrawn from the pocket or purse 70 by an accelerated motion shown by the acceleration vector 58″ causing the acceleration detection subsystem comprising the acceleration detector 62′, A/D converter 64, and acceleration threshold logic 66′ and the processor 20 in the host device 100A to determine that the acceleration level is greater than a predetermined threshold, resulting in the host device 100A sending a Discovery Start command to the NFC controller 102A to activate NFC polling based on the discovery parameters, according to an embodiment of the present invention.

FIG. 12F is an example embodiment of a flow diagram of operational steps of an example embodiment of the method carried out between the host device and the NFC controller of FIG. 12E, from the point of view of the host device 100A, for initializing the NFC controller 102A by sending a Set command with discovery parameters for formatting an NFC discovery period to increase a probability of discovering another NFC device, detecting an acceleration level, and sending a command to the NFC controller to start NFC discovery based on the discovery parameters, if the detected acceleration level is greater than a predetermined threshold, according to an embodiment of the present invention. The steps of the flow diagram represent computer code instructions stored in the RAM and/or ROM memory of the host device 100A, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 1212: providing to an NFC controller, discovery parameters for formatting an NFC discovery period to increase a probability of discovering another NFC device.

Step 1214: detecting acceleration level.

Step 1216: sending a command to the NFC controller to initiate NFC discovery based on the discovery parameters, if the detected acceleration level is greater than a predetermined threshold.

FIG. 12G is an example embodiment of a flow diagram of operational steps of an example embodiment of the method carried out between the host device and the NFC controller of FIGS. 12A, 12B, 12C, and 12E, from the point of view of the NFC controller 102A, for receiving a Set command with discovery parameters from the host device for formatting an NFC discovery period to increase a probability of discovering another NFC device, generating a sequence of NFC discovery periods having a format based on the received parameters, the generating being initiated in response to detecting a change in an ambient condition, and initiating transmission of NFC discovery RF signals according to the generated sequence of NFC discovery periods. The steps of the flow diagram represent computer code instructions stored in the RAM and/or ROM memory of the NFC controller 102A, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 1252: receiving parameters for formatting a near-field communication discovery period.

Step 1254: generating a sequence of near-field communication discovery periods, each discovery period having a format based on the received parameters for formatting, the generating being initiated in response to detecting a change in an ambient condition.

Step 1256: initiating transmission of near-field communication discovery radio frequency signals according to the generated sequence of near-field communication discovery periods.

The change in the ambient condition may be an ambient light level detected to be greater than a predetermined threshold. Alternately or in combination with the light level detection, the change in the ambient condition may be an acceleration level detected to be greater than a predetermined threshold.

In an example embodiment of the invention, the NFC controller 102A of FIGS. 12A, 12B, 12C, and 12E may include an ambient light detection subsystem and/or an acceleration detection subsystem that may be used to trigger the processor 20 in the NFC controller 102A to generate the sequence of near-field communication discovery periods, each discovery period having a format based on the received parameters for formatting, the generating being initiated in response to detecting a change in an ambient light level and/or an acceleration level, according to an embodiment of the present invention.

Example embodiments of the invention include an apparatus comprising:

means for receiving parameters for formatting a near-field communication discovery period to increase a probability of discovering another near-field communication device;

means for generating a sequence of near-field communication discovery periods, each discovery period having a format based on the received parameters for formatting; and

means for initiating transmission of near-field communication discovery radio frequency signals according to the generated sequence of near-field communication discovery periods.

Example embodiments of the invention include an apparatus comprising:

means for receiving a maximum value and a minimum value for a total duration of a near-field communication discovery period;

means for generating a sequence of random total durations of the near-field communication discovery period having values between the maximum value and the minimum value for the total duration of the near-field communication discovery period; and

means for initiating transmission of near-field communication discovery radio frequency signals according to the sequence of random total durations of the near-field communication discovery period.

Example embodiments of the invention include an apparatus comprising:

means for receiving a maximum value and a minimum value for a listen interval of a near-field communication discovery period;

means for generating a sequence of random listen interval values between the maximum value and the minimum value for the listen interval of the near-field communication discovery period; and

means for initiating transmission of near-field communication discovery radio frequency signals of a plurality of near-field communication discovery periods each including a random listen interval value.

Example embodiments of the invention include an apparatus comprising:

means for receiving an idle interval replacement value for a periodic replacement of an idle interval by a listen interval of a near-field communication discovery period;

means for periodically replacing the idle interval with the listen interval of the near-field communication discovery period, the replacing being at a rate corresponding to the replacement value; and

means for initiating transmission of near-field communication discovery radio frequency signals of a plurality of near-field communication discovery periods, including a periodic near-field communication discovery period wherein the idle interval is replaced with the listen interval.

Example embodiments of the invention include an apparatus comprising:

means for receiving a maximum value and a minimum value for an idle interval of a near-field communication discovery period;

means for generating a sequence of random idle interval values between the maximum value and the minimum value for the idle interval of the near-field communication discovery period; and

means for initiating transmission of near-field communication discovery radio frequency signals of a plurality of near-field communication discovery periods each including a random idle interval value.

Example embodiments of the invention include an apparatus comprising:

means for accessing a regional database to determine if there are certain near-field communication technologies that are not in use locally; and

means for providing to a near-field communication controller discovery parameters for those near-field communication technologies being used in the local region, to reduce unnecessary polling and enable longer listening intervals in near-field communication discovery.

Example embodiments of the invention include an apparatus comprising:

means for providing to a near-field communication controller, discovery parameters for formatting a near-field communication discovery period to increase a probability of discovering another near-field communication device;

means for detecting a change in an ambient condition; and

means for sending a command to the near-field communication controller to start near-field communication discovery based on the discovery parameters, if the detected change is greater than a predetermined threshold.

Example embodiments of the invention include an apparatus comprising:

means for receiving parameters for formatting a near-field communication discovery period.

means for generating a sequence of near-field communication discovery periods, each discovery period having a format based on the received parameters for formatting, the generating being initiated in response to detecting a change in an ambient condition.

means for initiating transmission of near-field communication discovery radio frequency signals according to the generated sequence of near-field communication discovery periods.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention.

What is claimed is:

1. A method, comprising:
receiving parameters for formatting a near-field communication discovery period;
generating a sequence of near-field communication discovery periods, each discovery period having a format based on the received parameters for formatting; and
initiating transmission of near-field communication discovery radio frequency signals according to the generated sequence of near-field communication discovery periods.

2. The method of claim 1, further comprising:
the received parameters for formatting including a maximum value and a minimum value for a total duration of the near-field communication discovery period; and
the generated sequence being a sequence of near-field communication discovery periods having random total durations with values between the maximum value and the minimum value for the total duration of the near-field communication discovery period.

3. The method of claim 1, further comprising:
the received parameters for formatting including a maximum value and a minimum value for a listen interval of the near-field communication discovery period; and
the generated sequence being a sequence of near-field communication discovery periods having random listen intervals with values between the maximum value and the minimum value for the listen interval of the near-field communication discovery period.

4. The method of claim 1, further comprising:
the received parameters for formatting including an idle interval replacement value for a periodic replacement of an idle interval by a listen interval of a near-field communication discovery period; and
the generated sequence being a sequence of near-field communication discovery periods including periodically occurring near-field communication discovery periods having the idle interval replaced with the listen interval, the replacing being at a rate corresponding to the replacement value.

5. The method of claim 1, further comprising:
the received parameters for formatting including a maximum value and a minimum value for an idle interval of the near-field communication discovery period; and
the generated sequence being a sequence of near-field communication discovery periods having random idle intervals with values between the maximum value and the minimum value for the idle interval of the near-field communication discovery period.

6. The method of claim 1, further comprising:
initiating said generation of a sequence of near-field communication discovery periods in response to detecting a change in an ambient condition.

7. The method of claim 6, further comprising:
said ambient condition is an ambient light level detected to be greater than a predetermined threshold.

8. The method of claim 6, further comprising:
said ambient condition is an acceleration level detected to be greater than a predetermined threshold.

9. An apparatus, comprising:
at least one processor;
at least one memory including computer program code;
the at least one memory and the computer program code configured to, with the at least one processor, cause the apparatus at least to:
receive parameters for formatting a near-field communication discovery;
generate a sequence of near-field communication discovery periods, each discovery period having a format based on the received parameters for formatting; and
initiate transmission of near-field communication discovery radio frequency signals according to the generated sequence of near-field communication discovery periods.

10. The apparatus of claim 9, further comprising:
the received parameters for formatting including a maximum value and a minimum value for a total duration of the near-field communication discovery period; and
the generated sequence being a sequence of near-field communication discovery periods having random total durations with values between the maximum value and the minimum value for the total duration of the near-field communication discovery period.

11. The apparatus of claim 9, further comprising:
the received parameters for formatting including a maximum value and a minimum value for a listen interval of the near-field communication discovery period; and
the generated sequence being a sequence of near-field communication discovery periods having random listen intervals with values between the maximum value and the minimum value for the listen interval of the near-field communication discovery period.

12. The apparatus of claim 9, further comprising:
the received parameters for formatting including an idle interval replacement value for a periodic replacement of an idle interval by a listen interval of a near-field communication discovery period; and
the generated sequence being a sequence of near-field communication discovery periods including periodically occurring near-field communication discovery periods having the idle interval replaced with the listen interval, the replacing being at a rate corresponding to the replacement value.

13. The apparatus of claim 9, further comprising:
the received parameters for formatting including a maximum value and a minimum value for an idle interval of the near-field communication discovery period; and
the generated sequence being a sequence of near-field communication discovery periods having random idle intervals with values between the maximum value and the minimum value for the idle interval of the near-field communication discovery period.

14. The apparatus of claim 9, further comprising:
the at least one memory and the computer program code configured to, with the at least one processor, cause the apparatus at least to:
initiate said generation of a sequence of near-field communication discovery periods in response to detecting a change in an ambient condition.

15. The apparatus of claim 14, further comprising:
said ambient condition is an ambient light level detected to be greater than a predetermined threshold.

16. The apparatus of claim 14, further comprising:
said ambient condition is an acceleration level detected to be greater than a predetermined threshold.

17. A computer readable medium storing program instructions, which when executed by a computer processor, performs steps, comprising:
receiving parameters for formatting a near-field communication discovery period;
generating a sequence of near-field communication discovery periods, each discovery period having a format based on the received parameters for formatting; and
initiating transmission of a near-field communication discovery radio frequency signals according to the generated sequence of near-field communication discovery periods.

18. The computer readable medium storing program instructions of claim 17, further comprising:
the received parameters for formatting including a maximum value and a minimum value for a total duration of the near-field communication discovery period; and
the generated sequence being a sequence of near-field communication discovery periods having random total durations with values between the maximum value and the minimum value for the total duration of the near-field communication discovery period.

19. The computer readable medium storing program instructions of claim 17, further comprising:
the received parameters for formatting including a maximum value and a minimum value for a listen interval of the near-field communication discovery period; and
the generated sequence being a sequence of near-field communication discovery periods having random listen intervals with values between the maximum value and the minimum value for the listen interval of the near-field communication discovery period.

20. The computer readable medium storing program instructions of claim 17, further comprising:
the received parameters for formatting including an idle interval replacement value for a periodic replacement of an idle interval by a listen interval of a near-field communication discovery period; and
the generated sequence being a sequence of near-field communication discovery periods including periodically occurring near-field communication discovery periods having the idle interval replaced with the listen interval, the replacing being at a rate corresponding to the replacement value.

21. The computer readable medium storing program instructions of claim 17, further comprising:
the received parameters for formatting including a maximum value and a minimum value for an idle interval of the near-field communication discovery period; and
the generated sequence being a sequence of near-field communication discovery periods having random idle intervals with values between the maximum value and the minimum value for the idle interval of the near-field communication discovery period.

22. The computer readable medium storing program instructions of claim 17, which when executed by a computer processor, performs the step, further comprising:
initiating said generation of a sequence of near-field communication discovery periods in response to detecting a change in an ambient condition.

23. A method, comprising:
accessing a regional database to determine if there are certain near-field communication technologies that are not in use locally; and
providing to a near-field communication controller, discovery parameters for those near-field communication technologies being used in the local region, to reduce unnecessary polling and enable longer listening intervals in near-field communication discovery.

24. The method of claim 23, further comprising:
sending to the near-field communication controller, a command to initiate generation of a sequence of near-field communication discovery periods, each discovery period having a format based on the provided discovery parameters, if a change in an ambient condition has been detected.

25. An apparatus, comprising:
at least one processor;
at least one memory including computer program code;
the at least one memory and the computer program code configured to, with the at least one processor, cause the apparatus at least to:
access a regional database to determine if there are certain near-field communication technologies that are not in use locally; and
provide to a near-field communication controller, discovery parameters for those near-field communication technologies being used in the local region, to reduce unnecessary polling and enable longer listening intervals in near-field communication discovery.

26. The apparatus of claim 25, further comprising:
the at least one memory and the computer program code configured to, with the at least one processor, cause the apparatus at least to:
send to the near-field communication controller, a command to initiate generation of a sequence of near-field communication discovery periods, each discovery period having a format based on the provided discovery parameters, if a change in an ambient condition has been detected.

27. A computer readable medium storing program instructions, which when executed by a computer processor, performs steps, comprising:
accessing a regional database to determine if there are certain near-field communication technologies that are not in use locally; and
providing to a near-field communication controller, discovery parameters for those near-field communication technologies being used in the local region, to reduce unnecessary polling and enable longer listening intervals in near-field communication discovery.

28. The computer readable medium storing program instructions of claim 27, which when executed by a computer processor, performs the step, further comprising:
sending to the near-field communication controller, a command to initiate generation of a sequence of near-field communication discovery periods, each discovery period having a format based on the provided discovery parameters, if a change in an ambient condition has been detected.
